(19) United States
(12) Patent Application Publication
(10) Pub. No.: US 2026/0241359 A1
(43) Pub. Date: Aug. 20, 2026

(54) REACTORS AND THEIR SPECIAL DESIGN SUITABLE FOR A HIGH FLEXIBLE AND ROBUST POLYCARBONATE PLANT, IN PARTICULAR BY MEANS OF A PRE-TRANSESTERIFICATION TECHNOLOGY

(71) Applicant: EPC-Engineering & Technologies GmbH, Arnstadt (DE)

(72) Inventor: Michael STRENG, Maintal (DE)

(21) Appl. No.: 18/869,745

(22) PCT Filed: Sep. 18, 2023
(86) PCT No.: PCT/EP2023/075670

§ 371 Date: Nov. 26, 2024

(51) Int. Cl. B01J 19/00; B01J 19/18; C08G 64/20

(52) U.S. Cl. CPC B01J 19/0013; B01J 19/0066; B01J 19/1862; C08G 64/205; B01J 2219/00081; B01J 2219/00083; B01J 2219/0009; B01J 2219/00094; B01J 2219/00159; B01J 2219/00162; B01J 2219/00337; B01J 2219/185

(57) ABSTRACT

The invention relates to a reactor comprising a) a heating zone provided with heating means for heating a raw material melt mixture to a predetermined temperature, b) a reaction zone for reacting the heated raw material melt mixture, wherein the reaction zone is located above the heating zone and provided with mixing means, c) an inlet for the raw material melt mixture at the bottom of the heating zone and d) an outlet for the reacted raw material melt mixture at the top of the reaction zone, wherein the reactor is configured to carry out the reaction at a pressure of equal to or above 1 bar (a) in the reaction zone entirely filled with the heated fluid raw material mixture flowing through the reaction zone. The invention further relates to a unit comprising i) said reactor as a first reactor and ii) a second reactor provided with inlet nozzles, and at least one outlet for removing evaporated by-products, wherein the second reactor is configured to further react the reacted raw material melt mixture received from the first reactor at a pressure of below 1 bar (a) to generate a reaction mixture, wherein the first reactor and the second reactor are connected in series in this order.

The reactor and the unit are suitable as an element in a plant for continuous production of a polymer, preferably a polycarbonate, which improves the robustness and/or flexibility of the production and enables production of high quality polymers.

The present invention relates to a reactor and a unit comprising said reactor as a first reactor and a second reactor wherein the first and second reactors are connected in series in this order, wherein the reactor and the unit are suitable as an element in a plant for continuous production of polymers, in particular polycarbonates.

Polycarbonates are polymeric esters of carbonic acid with diols. Because of their interesting physical properties, such as low weight, good temperature and impact resistance, and excellent optical properties, polycarbonates are used for many products in the high-tech field. As a result, there is a continuously growing demand for high-quality polycarbonate.

Polycarbonate can be produced by polycondensation of phosgene with diols or, avoiding the highly toxic phosgene, by the “non-phosgene” melting process, generally carried out by a transesterification reaction of diaryl carbonates with bisphenols in a melt transesterification process and following polycondensation. The production of polycarbonates from bisphenols and diaryl carbonates by the melt transesterification process mainly consists of three reaction sections, namely transesterification (production of monomers), pre-polycondensation (also oligomerisation) and final polycondensation, each of which generally takes place in the presence of one or more suitable catalysts.

The production of polycarbonates according to the melt transesterification process is known, and described e.g. in Dres. U. Grigo, K. Kircher and P. R. Müller “Polycarbonate” in Becker/Braun, Kunststoff Handbuch, Vol. 3/1, Polycarbonate, Polyacetale, Polyester, Celluloseester, Carl Hanser Verlag, Munich, Vienna 1992, pages 117-299.

A melt transesterification process according to the prior art is described for instance in WO 2013/189823 A1.

This phosgene-free melting process starts with a transesterification reaction of carbonic acid diesters, especially diaryl carbonate such as diphenyl carbonate (DPC) or also carbonic acid diphenyl ester (CAS no. 102-09-0) with bisphenols, especially bisphenol-A (BPA, CAS no. 80-05-7) to the transesterification product or monomers, followed by subsequent polycondensation to the polymer with elimination of hydroxyaryl compound such as phenol, and ending with the finished polymer. The polycarbonate obtained has a desired molecular weight, represented by the so-called melt-flow index MFI value, or also MVR or MFR, with a constant and as low as possible polydispersity Mw/Mn.

In particular, today's continuous non-phosgene melt-phase process is carried out in a continuous production plant (CP), ultimately leading to the production of polycarbonate in granulate form (polycarbonate chips or pellets).

With BPA and DPC as exemplary raw materials, this continuous production plant is essentially based on the following plant areas:
1. Raw material storage and supply: Unloading, conveying and feeding equipment of the raw materials such as BPA and DPC.
2. Catalyst system: Preparation units of the catalyst system for transesterification and polycondensation (transesterification and polycondensation catalysts) and their associated dosing devices for continuous dosing of the catalysts before or within the sections of the transesterification and/or polycondensation within the CP.
3. Premix: A raw material mixing tank and its associated discharge pump and preheater.
4. Transesterification: Multi-stage transesterification reaction by means of several stirred tanks or similar devices connected in series with connected process column, or further separation columns, for further processing of the separated process hydroxylauryl compound such as phenol, and the necessary unit(s) of process vacuum generation.
5. Polycondensation: One-stage or multi-stage pre-polycondensation and final polycondensation, with specially adapted pre- and final polycondensation reactors, with respective associated process steam condensation system, and the necessary process vacuum generation units.
6. Extrusion: Individual feeding or distribution of the polymer melt to one or more melt extruders for the incorporation of additives.
7. Supply system for additives: Additive preparation units and dosing devices for continuous feeding of the selected additives into a special extruder for introduction into the polymeric polycarbonate melt and before the granulation unit of the CP.
8. Filtration and granulation: Polymer melt filtration followed by one or more granulation units for chip production.
9. Granulate drying and cooling: polycarbonate chip production with melt strand casting head, strand guiding device and water-cooling section, pelletising unit, drying and screening.
10. Product storage and packaging: Intermediate storage and removal in silos, quality controls and filling e.g., in containers, big bags or similar.

The quality of the polycarbonate granulates to be achieved is not only described by the average molecular weight and the corresponding melt flow index MFI, but also by a number of physical, thermal and optical material properties and other characteristic values of the polycarbonate granulate which are determined by particular material tests.

Optical characteristic values as well as mechanical resistance values, especially impact strength, seem to be influenced by the polymeric basic structure. For instance, the content of polymeric cross-linkings in the polycarbonate material visible as so-called “gel nodules” form optical limitations and lead to material weak points in the polymer structure called “brittleness”.

An indirect measure for the development of branching in the polymer is an (increasing) polydispersity Mw/Mn. That is, the wider the molar mass distribution, i.e., the larger the value Mw/Mn becomes, the more polymeric branching and cross-linking is present within the polymer structure.

There can be various reasons for this increasing polydispersity:
a. Organic raw material impurities or pre-damage in the BPA and/or DPC leading to Fries rearrangement reactions in the first transesterification phase and further to branching resulting in cross-links in the polymer.
b. Radical-mediated oxidative (degradation) reactions caused by an unwanted presence of oxygen in the reaction phase.
c. High thermal load of the polymer or polymer components over a simultaneously high residence time in the process.
d. Very excessive amounts of catalyst added, which can also trigger degradation reactions.
e. Insufficient and/or fluctuating reaction conversion of BPA in the first transesterification phase, which leads to formation of isopropenylphenol (IPP) due to BPA degradation and therefore to insufficiently reacted short-chain polymer structures later on.

In summary, a high-quality polycarbonate mainly consists of linear chains of a desired chain length. Deviations from this, such as high polydispersity (Mw/Mn) and branching, lead to altered mechanical, in particular reduced impact strength, and rheological properties, which can have a negative effect in further processing.

The production of high-quality polycarbonate with the known processes of the prior art is difficult and generally specific measures such as post-treatments are necessary.

Thus, it is generally known that the impact strength of a polycarbonate product can be improved by blending with co-polymers as described e.g., in WO 2017/081640 A1, DE 3325056 A1, DE 3326562 A1, and DE 3856568 T2. The disadvantage, however, is that this process is referred to as “post-treatment” or “post-polycarbonate manufacturing processing” to obtain the desired quality of polycarbonate. This requires higher investments.

Further possible post-treatment to improve the properties of manufactured polycarbonate, in particular the polydispersity thereof, is fractionation. To obtain the desired polydispersity, it is generally necessary to subject the polymers to a separation process, such as disclosed in DE 3242130 A1 and EP 01468026 B1. The disadvantage of such processes is that an optimal balance between chain length and branching in the polymer has not yet been found. Furthermore, the energy and equipment required for this additional treatment is significantly higher.

EP 1368406 B1 is directed to an optimization of polycarbonate preparation by transesterification, wherein the amount of catalysts are adapted to the quality of the raw materials used. The method requires an analysis of the raw materials and, moreover, a change in the quality of the raw materials used requires an adaption in the process conditions.

From the above, it is also clear that a high and constant quality of raw materials is a premise for the production of high-quality polycarbonate at present.

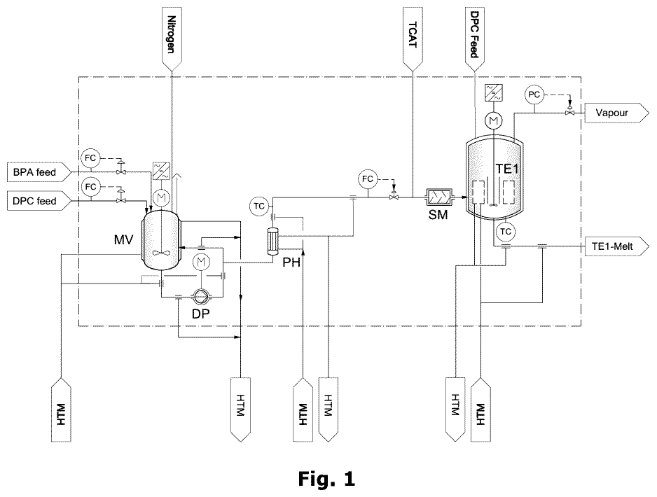

For example, the inventors have tested production of polycarbonate in a melt transesterification process according to the prior art, in which the initial phase was designed as described in FIG. 1 based on raw materials BPA and DPC having a minor quality, which resulted in an not acceptable high polydispersity of the polycarbonate obtained (cf. Reference example 1).

Similar problems also occur in the continuous production of polymers, in particular polyesters, based on raw material melt mixtures, in particular where the polymerization or polycondensation, including transesterification, is carried out in multiple steps.

The object of the present invention was to overcome the disadvantages of the prior art as discussed above. Specifically, the task underlying the present invention was to provide reactors with a specific design or units of such reactors which are suitable as an element in a plant for production of a polymer, in particular a polycarbonate, in a continuous process to improve the production of high-quality polymers, in particular polyesters such as polycarbonates, in particular with a sufficiently low polydispersity, whereby no post-treatment steps are necessary to correct the quality.

A further object of the invention was to provide reactors with a specific design or units of such reactors for use in a plant for the continuous production of high-quality polymers, in particular polyesters such as polycarbonates which a high flexibility and robustness. Robustness means that fluctuation in the quality of the raw materials used such as bisphenols and/or diaryl carbonates does not essentially effect the quality of the polymer prepared, in particular a polyester such as polycarbonate. Flexibility means that fluctuation in term of throughput of plant does not essentially effect the quality of the polymer prepared.

The inventors found that these problems could surprisingly be solved by a reactor having a specific design or a unit comprising said specific reactor and a second reactor adapted to the specific reactor and connected thereto in series. In particular, the new reactor and unit enable to employ a novel pre-transesterification reaction technology within a melt transesterification process for preparing a polyester, in particular a polycarbonate. In particular, the new technology can be implemented in a plant for preparing a polymer such as a polyester, in particular a polycarbonate, by means of the specific reactor used as a pre-transesterification reactor.

The invention is inter alia based on the inventors' assessment that it is of utmost importance to introduce a specific pre-transesterification reaction to optimize and improve control of the following reactions taking place throughout the process, in order to produce a high-quality polymer such as a polyester, in particular a polycarbonate, with low polydispersity without having to correct the polycarbonate afterwards. This goal can be achieved with the reactor of the invention or the unit of the invention, respectively.

Accordingly, the present invention is directed to a reactor, in particular suitable as an element in a plant for continuous production of a polymer, preferably a polycarbonate, based on a raw material melt mixture, wherein the reactor comprises
a) a heating zone provided with one or more heating means for heating the raw material melt mixture to a predetermined temperature,
b) a reaction zone for reacting the heated raw material melt mixture, wherein the reaction zone is located above the heating zone and provided with one or more mixing means,
c) an inlet for the raw material melt mixture at the bottom of the heating zone and
d) an outlet for the reacted raw material melt mixture at the top of the reaction zone,
wherein the reactor is configured to carry out the reaction at a pressure of equal to or above 1 bar (a) in the reaction zone entirely filled with the heated raw material melt mixture flowing through the reaction zone.

The present invention is also directed to a unit, in particular suitable as a component in a plant for continuous production of a polymer, preferably a polycarbonate, based on a raw material melt mixture, wherein the unit comprises
i) a first reactor which is the reactor of the invention as described above and below, and
ii) a second reactor provided with one or more inlet nozzles for receiving the reacted raw material melt mixture from the first reactor, and at least one outlet for removing evaporated by-products, wherein the second reactor is configured to further react the reacted raw material melt mixture received from the first reactor at a pressure of below 1 bar (a) to generate a reaction mixture with a gaseous phase filling an upper part of the reactor where the one or more inlet nozzles are located,
wherein the first reactor and the second reactor are connected in series in this order.

A particular benefit of the reactor of the invention is that it is possible to carry out a reaction, in particular a transesterification reaction, in the reactor based on a raw material melt mixture to the desired conversion degree or transesterification degree, in particular a conversion degree or a transesterification degree in or near to the equilibrium state, in a short time so that the dwell time in the reactor can be kept short. A short dwell time is also beneficial to minimize undesired side reactions. The by-product generated in the reaction or transesterification, which is e.g. a monomeric alcohol compound, is retained in the reacted raw material melt mixture, i.e. there is no removal of such by-products in the reactor.

This benefit is of course also achieved with the unit of the invention. An additional benefit of the unit of the invention, where the reactor of the invention (first reactor) is connected to a second reactor is that due to configured pressure difference between the first and second reactors a flash evaporation of by-products such as alcohol compounds in the reacted raw material melt mixture of the first reactor entering the second reactor can be achieved before the reacted raw material melt combines with the reaction mixture contained in the second reactor. This is advantageous because reverse or degradation reaction that would occur within the reaction mixture of the second reactor due to the presence of the by-products such as alcohol compounds can be avoided or minimized.

According to a preferred embodiment of the inventive unit, the second reactor is further provided with an overflow means such as an overflow balcony, by which the reacted raw material melt mixture entering the second reactor can form a falling film facilitating further evaporation of residual by-products after flash evaporation so that an effective and maximum evaporation of the by-products can be achieved.

As a result, the employment of the reactor of the invention or the unit of the invention, respectively, in a plant for the continuous production of a polymer such as a polycarbonate shows a significant improvement in the process parameters and the quality of the polymers produced as compared to the use of plants including conventional reactors.

For instance, the incorporation of pre-transesterification reaction technology by using the reactor of the invention as a pre-transesterification reactor in a plant for the continuous production of polycarbonate, e.g. according to the process of invention as described below, makes it possible to bring the raw material melt mixture already to a required degree of transesterification of e.g. >79% within a residence time or reaction time of e.g., about 4 minutes before entering a first transesterification reactor operating under vacuum.

It was further surprisingly established that this result can be achieved regardless of production fluctuations with regard to throughput of the polycarbonate production plant, or variations in the quality of the raw materials to be used (bisphenol such as BPA or diaryl carbonate such as DPC).

Accordingly, the problem of obtaining a polycarbonate with increased polydispersity is substantially reduced by this invention. Without wishing to be bound to any theory, it is believed that the problem of increasing polydispersity which is solved by the present invention is essentially the result of causes a. and e. mentioned above.

In fact, whereas a process in a plant according to the prior art using an initial phase according to FIG. 1 and raw materials of minor quality, in particular a BPA raw material having a fluctuating content of organic impurities and low average purity level, resulted in low quality polycarbonate having a polydispersity between 6 and 13 as discussed above, the modification of the process by implementing the reactor of the invention as a pre-transesterification reactor enabled the production of high quality polycarbonate having a significantly decreased polydispersity of about 2.7 to 3.

The present invention differs from all existing prior art plant designs in particular by the pre-transesterification technology implemented by the reactor of the invention in the first transesterification phase. The reactor of the invention enables pre-transesterification before the main transesterification process in a controlled and targeted manner enabling an optimal and very short residence time and a high degree of conversion so that a high-quality polycarbonate with low polydispersity can be produced.

The use of the inventive reactor with special design or the corresponding inventive unit in a plant for the continuous production of a polymer such as polycarbonate offers the advantage not only with regard to the low dispersity of the polymer or polycarbonate produced, and hence also better impact strength, but also ensures the required polydispersity in the final polycarbonate product, regardless of intentional or unintentional changes in the throughput rate of the polymer or polycarbonate production plant and fluctuations in the quality of the raw materials. In other words, the inventive reactor and the corresponding inventive unit increase the “robustness” and the “flexibility” of a polymer production plant such as a polycarbonate production plant.

Apart from this novel pre-transesterification reaction technology by employing the inventive reactor as a pre-transesterification reactor or the inventive unit, the general plant and process for preparing polymer such as polycarbonate may be similar to the plants and processes according to the prior art.

The inventive reactor and the inventive unit can establish a pre-transesterification reaction technology which is suitable for use in
a) the new construction of a polyester plant such as a polycarbonate plant, or
b) the reconstruction of an existing polyester plant such as a polycarbonate plant by implementation of the inventive reactor as a pre-transesterification reactor to improve polyester or polycarbonate quality, or
c) the expansion of the production capacity of polycarbonate from conventional “non-phosgene” polycarbonate plants.

In particular in a production plant for the continuous preparation of polycarbonate, the implementation of the reactor of the invention as a pre-transesterification reactor as a real, first reaction stage for transesterification can lead to an improved and more consistent polycarbonate end quality, in particular with respect to the mechanical impact strength properties and especially—but not only—with respect to the optical application range of the finished polycarbonate.

The accompanying drawings show in:

FIG. 1 a process scheme of the initial phase of a melt transesterification process for the preparation of polycarbonate,

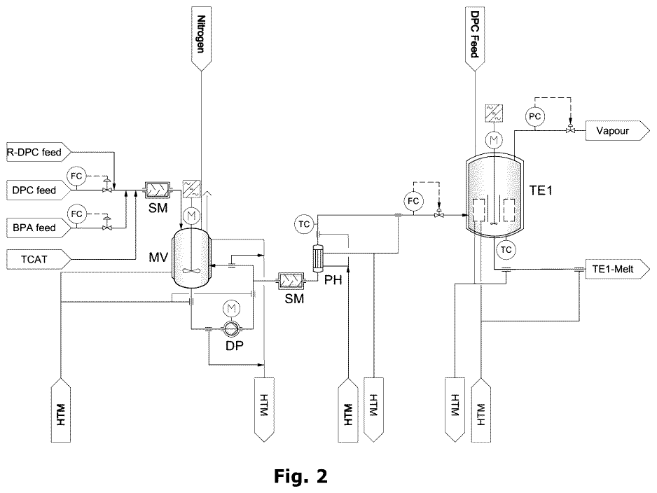

FIG. 2 a modified process scheme of the initial phase of a melt transesterification process for the preparation of polycarbonate

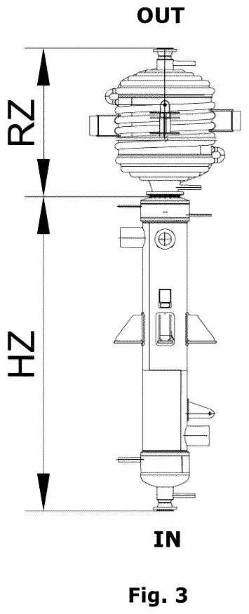

FIG. 3 a schematic side view of a preferred example of the reactor of the invention, which is particularly suitable as a pre-transesterification reactor in a process and plant for the continuous production of a polymer such as polycarbonate

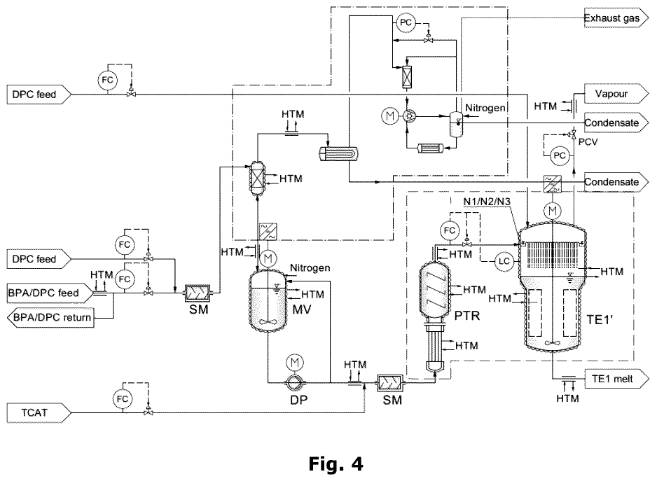

FIG. 4 a process scheme of a melt transesterification process as part of the process for preparation of polycarbonate including the unit according to the invention, wherein the first reactor is used as a pre-transesterification reactor and the connected second reactor is used as a first transesterification reactor

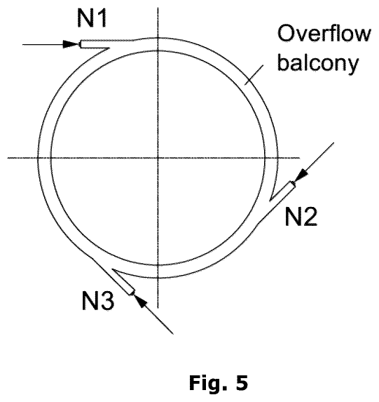

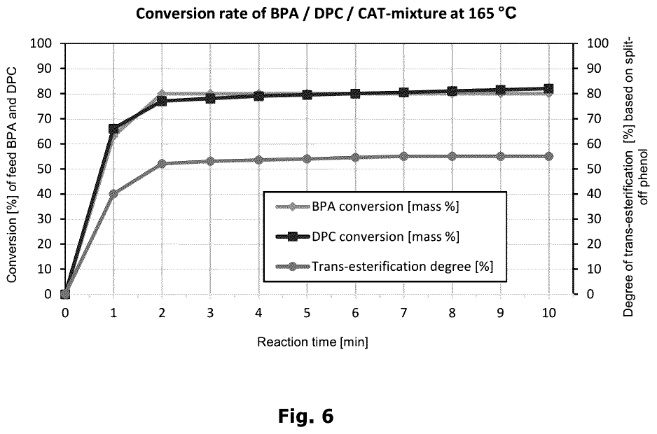

FIG. 5 a top view of an example of the second reactor of the unit of the invention provided with an overflow balcony and the feed direction of the reaction mixtures in the plane of the overflow balcony

FIG. 6 a graph showing the reaction behavior and transesterification degree as the result of pre-transesterification test with respect to transesterification according to Reference example 2

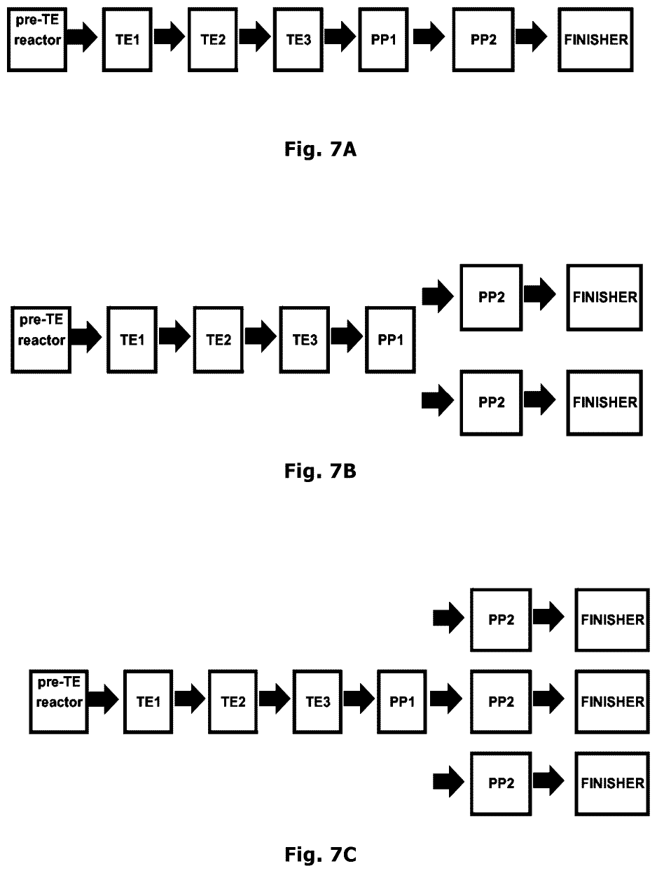

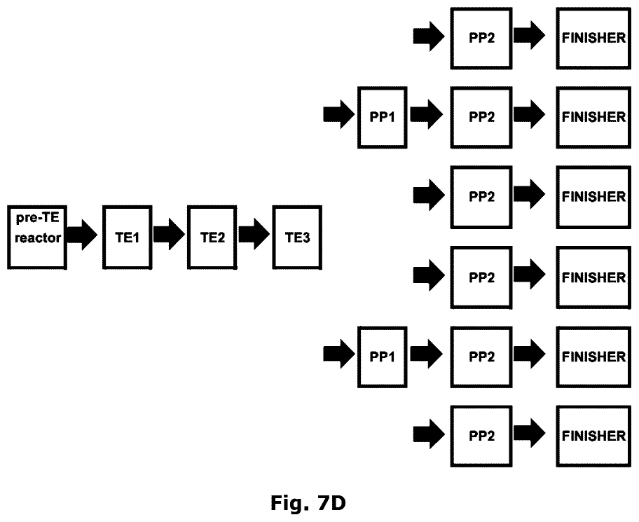

FIG. 7A-D process block diagrams of preferred process and plant configurations including one production line or at least two parallel production lines.

In the following, the invention is described in more detail.

The polydispersity also called polydispersity index is used as a measure of the broadness of a molecular weight distribution of a polymer, and the polydispersity is defined by the ratio Mw/Mn, wherein Mw is the weight average molecular weight and Mn is the number average molecular weight of the respective polymer. Herein, the polydispersity values are determined by size exclusion chromatography according to DIN EN ISO 16014-5:2019-09.

The terms “reaction mixture” or “reaction mixture stream” as used herein refers in general to the reaction material and respective reaction material stream flowing through the reactors and units of the present invention and further reactors described herein and the connecting pipes between these reactors.

The units bar (a) and mbar (a) refer to the absolute pressure.

The reactor of the invention comprises a) a heating zone provided with one or more heating means for heating a raw material melt mixture to a predetermined temperature.

The heating zone provided with one or more heating means is preferably in form of a heat exchanger. It is however also conceivable that alternatively or additionally the heating zone may be provided with other external and/or internal heating means such as heating jackets or heating coils.

In a most preferred embodiment, the heating zone provided with one or more heating means is in form of a tube-bundle heater configured to heat the raw material melt mixture in the tubes of the tube-bundle heater to a predetermined temperature. The tubes of the tube-bundle heater are surrounded by a heating medium.

The reactor of the invention further comprises b) a reaction zone for reacting the heated raw material melt mixture. The reaction zone is located above the heating zone and provided with one or more mixing means. The terms “reaction zone” and “reaction chamber” are used here interchangeably.

Thus, a raw material melt mixture fed in the reactor through the inlet of the reactor to the heating zone can be heated in the heating zone to a predetermined temperature to form a heated raw material melt mixture which flows in the overlying reaction zone of the reactor wherein the reaction of the heated raw material melt mixture substantially takes place.

The reaction zone is provided with mixing means in order to mix the heated raw material melt mixture. Any suitable mixing means may be used. In a preferred embodiment, the one or more mixing means in the reaction zone are one or more integrated static mixers.

The reaction zone is preferably further provided with heating means. The function of the heating means is to substantially maintain the temperature of the raw material melt mixture in the reaction zone, which has been heated in the heating zone to the predetermined temperature.

The heating means of the reaction zone may be internal and/or external heating means. Examples of suitable external heating means are one or more heating jackets or one or more external heating coils. Examples of suitable internal heating means are one or more internal heating coils and/or heating tubes.

The reactor of the invention further comprises c) an inlet for the raw material melt mixture at the bottom of the heating zone. Hence, a raw material melt mixture can be fed to the reactor through the inlet.

The inlet of the reactor is typically connected with a mixing vessel via a piping. In the mixing vessel the raw material melt mixture or a raw material melt as a precursor of the raw material melt mixture is prepared. Further ingredients of the raw material melt mixture such as one or more catalysts such as transesterification catalysts may be added to the raw material melt prepared in the mixing vessel during the transport to the reactor via the piping. In this case, it may be suitable to implement a mixing device in the connecting pipe after the addition point for the one or more transesterification catalysts to improve mixing.

The reactor of the invention further comprises d) an outlet for the reacted raw material melt mixture at the top of the reaction zone.

The reactor of the invention is configured to carry out the reaction, which is typically a transesterification reaction, preferably a pre-transesterification reaction, at a pressure of equal to or above 1 bar (a) in the reaction zone, preferably at a pressure in the range of 5 to 1 bar (a), more preferably from 5 to 1.1 bar (a), still more preferably from 3.5 to 1.5 bar (a), and most preferably from 3 to 2 bar (a).

The reactor of the invention is preferably configured to carry out the reaction, which is typically a transesterification reaction, preferably a pre-transesterification reaction, at a temperature in the range of 175 to 205° C., more preferably from 180 to 200° C., still more preferably from 185 to 195° C.

In a preferred embodiment, the reactor is configured to carry out the reaction typically a transesterification reaction, preferably a pre-transesterification reaction, in the reaction zone at a temperature in the range of 175 to 205° C., preferably from 180 to 200° C., more preferably from 185 to 195° C., and a pressure in the range of 5 to 1 bar (a), preferably from 5 to 1.1 bar (a), more preferably from 3.5 to 1.5 bar (a), more preferably from 3 to 2 bar (a).

The reactor of the invention is configured such that during operation the reaction zone is entirely filled with the heated raw material melt mixture flowing through the reaction zone. That is, a vapor phase is substantially not present in the pre-transesterification reactor during operation. The heating zone of the reactor is also preferably entirely filled with the raw material melt mixture.

The reactor of the invention is preferably a transesterification reactor, more preferably a pre-transesterification reactor. That is, the reactor is configured to carry out a transesterification reaction or pre-transesterification reaction.

The reactor of the invention is preferably a vertical reactor. FIG. 3 illustrates a preferred embodiment of the reactor.

The reactor generally does not contain outlets for removing possible by-products generated during the reaction in the reaction zone.

The raw material melt mixture passing through the reactor of the invention is heated in the heating zone and then enters the reaction zone. In general, the reaction such as transesterification reaction, in particular pre-transesterification, of the raw material melt mixture substantially takes place in the reaction zone. The reaction such as a pre-transesterification or transesterification reaction in the reaction zone usually represents an equilibrium reaction.

It is a particular advantage of the present invention that the reactor enables a reaction such as transesterification or pre-transesterification of the raw material melt mixture to the desired conversion degree or transesterification degree, in particular in or near to the equilibrium state, in a short time such as within an dwell time of 2 to 7 min, preferably 3 to 6 min, more preferably 4 to 5 min during which the raw material melt mixture is subject to the reaction.

In particular, it is preferred that the dwell time of the raw material melt mixture in the reaction zone of the reactor is 2 to 7 min, preferably 3 to 6 min, more preferably 4 to 5 min. During the dwell time it is possible to substantially or completely reach the reaction equilibrium of the reaction.

A benefit of the inventive reactor is that the reaction can be carried out to a high conversion degree, usually in or near to the equilibrium state, within a short time. In particular, this is true for transesterification or pre-transesterification reactions. For instance, the transesterification degree achieved may be in the range of 65% to 90%, preferably 75% to 85% and more preferably 79% to 83%. Further details on the transesterification degrees are described below in the discussion of the process of the invention to which reference is made.

Without wishing to be bound to any theory, it is believed that the capability of effecting a reaction such as transesterification or pre-transesterification to a rather high conversion or transesterification degree within a short time is one of the reasons for the high-quality polymer such as polyester, in particular polycarbonate, which can be achieved by the using the inventive reactor in a plant for continuous polymer production is due to the rather short term thermal load during reaction such as transesterification such as pre-transesterification in the reactor which should avoid unwanted side reactions. Moreover, such reaction can be achieved with moderate temperatures as compared to the conditions used in the prior art.

The reaction in the reaction zone of the inventive reactor is preferably a transesterification reaction, more preferably a partial transesterification reaction or pre-transesterification reaction. Pre-transesterification refers to an initial partial transesterification.

The reactor of the invention is particularly suitable as an element in a plant for continuous production of a polymer. A continuous production of a polymer means that the polymer is produced in a continuous process. The polymer to be produced is preferably a preferably a polyester, in particular a polycarbonate. The reactor of the invention is particularly suitable for a transesterification reaction, more preferably a pre-transesterification reaction, in a plant for the continuous production of a polyester, in particular a polycarbonate.

The reactor of the invention is configured for reaction of a raw material melt mixture, which can be fed to the reactor through the inlet of the reactor.

The raw material melt mixture generally comprises the raw material for producing the polymer, typically one or more monomers, and optionally a catalyst, for the reaction to be carried out in the reactor. Preferably, the raw material melt mixture comprises one or more polyol compounds such as diol compounds and one or more polyester compounds such as diester compounds and optionally one or more transesterification catalysts. The one or more polyol compounds such as diol compounds and the one or more polyester compounds such as diester compounds are usually monomeric compounds.

In a preferred embodiment, the raw material melt mixture to be reacted in the inventive reactor comprises one or more bisphenols, preferably bisphenol A, one or more diaryl carbonates, preferably diphenyl carbonate, and one or more transesterification catalysts. Suitable examples of the bisphenols, diaryl carbonates and transesterification catalysts and further details of the materials to be used and of the transesterification reaction which can be carried out in the inventive are described below so that reference is made thereto.

As mentioned before, the reaction to be carried out in the inventive reactor is usually a reaction in or near to the equilibrium state and in the reactor no by-products are removed from the reacted raw material melt mixture which leaves the reactor through the outlet.

Hence, the reacted raw material melt mixture usually contains unreacted raw materials, reaction products and usually monomeric by products. The reacted raw material melt mixture leaving the reactor is usually in or near the equilibrium state.

In the preferred embodiment, where the reaction is a transesterification or pre-transesterification, the reacted raw material melt mixture leaving from the outlet of the reactor is a partially transesterified reaction mixture typically comprising ester products such as monoesters, preferably monocarbonates, unreacted raw materials (polyols such as diols and polyesters esters such as diesters) and monomeric by-products such as alcohol compounds.

In the particular preferred embodiment, where the raw material melt mixture to be reacted by a transesterification reaction in the reactor comprises one or more bisphenols, one or more diaryl carbonates, and one or more transesterification catalysts, the state of the partially transesterified reaction mixture leaving through the outlet of the reactor is substantially saturated which means that the reaction equilibrium is reached. The composition of the partially transesterified reaction mixture (saturated monomer melt) comprises or consists mainly of
still unreacted raw materials, namely bisphenol such as bisphenol-A (BPA) and diarylcarbonate such as diphenyl carbonate (DPC), and
hydroxyaryl compound such as phenol cleaved by the pre-transesterification reaction of BPA with DPC, and
transesterification products or monomers obtained by transesterification reaction, here called monocarbonate (MC).

The invention also relates to a unit, in particular suitable as a component in a plant for continuous production of a polymer, preferably a polycarbonate, based on a raw material melt mixture, wherein the unit comprises
i) a first reactor which is the inventive reactor described above, and
ii) a second reactor provided with one or more inlet nozzles for receiving the reacted raw material melt mixture from the first reactor, and at least one outlet for removing evaporated by-products, wherein the second reactor is configured to further react the reacted raw material melt mixture received from the first reactor at a pressure of below 1 bar (a) to generate a reaction mixture with a gaseous phase filling an upper part of the reactor where the one or more inlet nozzles are located,
wherein the first reactor and the second reactor are connected in series in this order.

The inventive unit is particularly suitable as a component in a plant for continuous production of a polymer, preferably a polycarbonate, based on a raw material melt mixture in the same manner as the inventive reactor so that the above discussion with respect to the inventive reactor in this regard equally apply. Likewise, the first reactor is the inventive reactor described above so that the above discussion with respect to the inventive reactor equally apply. Reference is made thereto. In the following the second reactor of the inventive unit is described in more detail.

The second reactor is provided with one or more inlet nozzles for receiving the reacted raw material melt mixture from the first reactor, and at least one outlet for removing evaporated by-products. Of course, the second reactor has also at least one outlet for discharging the reaction mixture stream reacted therein for further processing. The discharged reaction mixture stream from the second reactor, which is preferably a transesterification reactor, is preferably fed to a further reactor, preferably a further transesterification reactor.

In order to remove evaporated by-products, the second reactors is generally connected with means such as distillation columns or process columns, respectively, for removal of the by-products. In this regard, the second reactor is also usually connected with a vacuum system which may include a process steam condensation stage, vacuum jet systems and vacuum pumps, in order to establish the desired pressure state.

The by-products which can be evaporated and removed from the second reactor can be alcohol compounds, usually monomeric alcohols, in particular hydroxyaryl compounds such as phenol. The by-products may optionally contain other volatile compounds.

The first reactor and the second reactor of the inventive unit are connected in series in this order, usually by one or more connecting pipes connecting the outlet of the first reactor with the one or more inlet nozzles of the second reactor.

The second reactor is configured to further react the reacted raw material melt mixture received from the first reactor at a pressure of below 1 bar (a), preferably at a pressure of 0.5 to 0.05 bar (a), more preferably 0.5 to 0.1 bar (a). The second reactor is preferably configured to carry out the reaction at a temperature in the range of 180 to 250° C., preferably 180 to 230° C.

In a preferred embodiment, the second reactor is configured to carry out the reaction at a temperature in the range of 180 to 250° C., preferably 180 to 230° C., and a pressure of 0.5 to 0.05 bar (a), preferably 0.5 to 0.1 bar (a).

The second reactor is preferably a transesterification reactor, i.e. a transesterification reaction can be carried out in the second reactor. Preferably, the second reactor is configured to continue the transesterification on the partially transesterified reaction mixture fed from the first reactor.

The second reactor is preferably a vertical reactor. In a preferred embodiment, the second reactor is a stirred-tank reactor. The second reactor, preferably in form of a stirred-tank reactor, is typically configured with internal and/or external heating means such as internal heat coils and/or external jacket heater.

The second reactor of the unit is configured such that during operation a gaseous phase fills an upper part of the reactor where the one or more inlet nozzles are located. In other words, the second reactor is configured such that during operation the reaction mixture contained in the second reactor does not fill the complete reactor but only a part thereof. The one or more inlet nozzles are located above the level of the reaction mixture such that the reacted raw material melt is introduced in the gaseous phase of the second reactor. The terms gaseous phase and vapor phase are used here interchangeably.

As mentioned above, the reacted raw material melt mixture, in particular the partially transesterified reaction mixture, generally includes by-products such as alcohol compounds, which are volatile. Since the presence of such by-products in the reaction mixture in the second reactor can cause undesired reverse or degradation reactions the removal of such by-products from the reacted raw material melt mixture before it combines with the reaction mixture is highly desired.

This can be achieved by the configuration of the second reactor which enables flash evaporation of by-products such as alcohols, in particular hydroxyaryl compounds such as phenol, in the reacted raw material melt mixture, in particular the partially transesterified reaction mixture, entering the second reactor. This flash evaporation can be achieved due to the pressure difference between the inlet pressure from the first reactor and the pressure in the first transesterification reactor. As mentioned, the reacted raw material melt mixture or partially transesterified reaction mixture fed from the first reactor enters the second reactor via the one or more inlet nozzles at a position above the level of the reaction mixture contained in the second reactor in order to enable said flash evaporation.

Thus, a large amount of by-products such as alcohols, in particular hydroxyaryl compounds such as phenol, contained in the entering reacted raw material melt mixture can be removed before combination with the reaction mixture by this flash evaporation.

In a preferred embodiment, the second reactor is equipped with a pressure regulating valve located at a vapor line to manage the pressure difference between the first reactor and the second reactor enabling controlled flash evaporation of by-products in the second reactor.

In a preferred embodiment, the second reactor is configured such that the reacted raw material melt mixture or partially transesterified reaction mixture fed from the first reactor enters the second reactor in form of a falling film. In order to obtain a falling film the second reactor is preferably configured with an overflow means such as an overflow balcony to which the reacted raw material melt mixture entering the second reactor through the one or more inlet nozzles is guided so that a falling film is formed when the reacted raw material melt mixture overflows the overflow means.

Such falling film is beneficial since it facilitates further evaporation of possible residual by-products included in the reacted raw material melt mixture after flash evaporation.

Hence, according to a preferred embodiment of the inventive unit, the second reactor is further provided with overflow means, preferably an overflow balcony, located at an upper portion of the second reactor, wherein the outlet of the first reactor is connected with the one or more inlet nozzles of the second reactor such that the reacted raw material melt mixture from the first reactor can be fed to the overflow means from which it can overflow to form a falling film in the gaseous phase of the second reactor.

It is preferred that the reacted raw material melt mixture from the first reactor can be tangentially fed to the overflow means via the one or more inlet nozzles. The overflow means, in particular the overflow balcony, is preferably disposed circumferentially at an inner wall of the second reactor.

In addition to the flash evaporation of the by products such as alcohols, in particular hydroxyaryl compounds such as phenol due to the pressure difference between the inlet pressure and the pressure in the second reactor, which is preferably controlled by the pressure regulating valve, the falling film generated supports further evaporation of remaining by-products. The falling film facilitates an effective and maximum evaporation of the residual by-products such as alcohols, in particular hydroxyaryl compounds such as phenol included in the reacted raw material melt mixture or partially transesterified reaction mixture after the flash evaporation.

The reaction carried out in the second reactor is preferably a transesterification reaction, in particular transesterification of the partially transesterified reaction mixture received from the first reactor is continued in the second reactor so that the transesterification degree is increased in the transesterified reaction mixture leaving the second reactor. In this regard, the second reactor functions as a first transesterification reactor. The transesterified reaction mixture is usually substantially a monomer mixture. Typically, at least one further transesterification reactor is connected to the second reactor in series in which the transesterification degree of the transesterified reaction mixture is further increased.

In a preferred embodiment of the unit according to the invention, the first reactor is a pre-transesterification reactor configured to form a partially transesterified reaction mixture as the reacted raw material melt mixture containing an alcohol compound as a by-product, wherein the raw material melt mixture preferably comprises one or more bisphenols, preferably bisphenol A, one or more diaryl carbonates, preferably diphenyl carbonate, and one or more transesterification catalysts, and the second reactor is a transesterification reactor configured to continue transesterification of the partially transesterified reaction mixture received from the first reactor and to remove the alcohol compound by-product generated in the first and second reactor.

The unit according to the invention preferably comprises one or more further reactors connected in series subsequently to the second reactor to further react the reaction mixture received from the second reactor. In a particular preferred embodiment, the unit comprises
i) the first reactor as a pre-transesterification reactor configured to receive and react the raw material melt mixture at a pressure equal to or above 1 bar (a) to form a partially transesterified reaction mixture containing a cleaved alcohol compound such as hydroxyaryl compound such as phenol as a by-product as the reacted raw material melt mixture,
ii) the second reactor as a first transesterification reactor configured to continue transesterification of the partially transesterified reaction mixture received from the first reactor at a pressure of below 1 bar (a) with continuous removal of the cleaved by-product,
iii) one or more further reactors comprising in this order
   a) at least one further transesterification reactor configured to continue transesterification of the transesterified reaction mixture received from the second reactor at a pressure of below 1 bar (a) with continuous removal of the cleaved by-product,
   b) at least one pre-polycondensation reactor configured to polycondense the transesterified reaction mixture received from the at least one further transesterification reactor at a pressure of below 1 bar (a) with continuous removal of the cleaved by-product to form a pre-polycondensation product, and
   c) a final polycondensation reactor configured to continue polycondensation of the pre-polycondensation product formed in the at least one pre-polycondensation reactor at a pressure of below 1 bar (a) to form a polyester, preferably a polycarbonate.

Usually, the transesterified reaction mixture is a monomer mixture, the pre-polycondensation product mainly comprises oligomers and the polycarbonate is a polymer with desired chain length.

In preferred embodiments of the unit of the invention,
the at least two transesterification reactors are stirred-tank reactors, and/or
at least one pre-polycondensation reactor is a stirred-tank reactor and a subsequent pre-polycondensation reactor is a horizontal agitated reactor, and/or
the final polycondensation reactor is a horizontal agitated reactor.

In preferred embodiments of the unit of the invention, the unit contains
i) a production line wherein the pre-transesterification reactor, the at least two transesterification reactors, the at least one pre-polycondensation reactor and the final polycondensation reactor are connected in series in this order, or
ii) at least two parallel production lines by splitting the production line before at least one of the at least one pre-polycondensation reactor into at least two parallel production lines wherein, considering the common reactors before each split, in each of the parallel production lines the mixing vessel, the pre-transesterification reactor, the at least two transesterification reactors, at least one pre-polycondensation reactor and a final polycondensation reactor are connected in series in this order.

In a preferred embodiment of the unit of the invention,
the at least two transesterification reactors are two or three transesterification reactors, and/or
in case of one production line the at least one pre-polycondensation reactor are two pre-polycondensation reactors, and in case of at least two parallel production lines the at least one pre-polycondensation reactor are two pre-polycondensation reactors in each of the parallel production lines considering the common reactors before each split for each respective parallel production line.

Further details with respect to the reactor of the invention and the unit of the invention are described below for the process of the invention which equally apply, in particular with respect to the process parameters and materials such as raw materials and catalysts used for the process so that reference is made thereto. In particular, details on the one or more further reactors suitable for the unit such as suitable pressure and temperature ranges for which the reactors should be configured are described there.

The invention is also related to a use of the reactor according to the invention as described above or of a unit according to the invention as described above as an element or component in a plant for continuous production of a polymer, preferably a polyester, more preferably a polycarbonate. All features and aspects described above for the reactor and the unit of the invention as well as all features and aspects described below for the process of the invention equally apply to the inventive use so that reference is made thereto.

In a preferred embodiment, the reactor or first reactor, respectively, is used to carried out a transesterification reaction on a raw material melt mixture to obtain a partially transesterified reaction mixture according to the new pre-transesterification technology described herein. It is further preferred that the second reactor is used to continue transesterification reaction on the partially transesterified reaction mixture received from the first reactor. In this regard, the second reactor is a transesterification reactor, preferably a first transesterification reactor of at least two transesterification reactors which are connected in series.

The inventive use is particularly suitable to improve the polydispersity of the polymer produced, in particular the polycarbonate produced. Moreover the inventive use is particularly suitable in order to improve the robustness and/or flexibility of the polymer production, in particular the polycarbonate production. Robustness here means that fluctuation in the quality of the raw materials used such as one or more bisphenols and/or one or more diaryl carbonates used as raw materials does not essentially effect the quality of the polycarbonate prepared. Flexibility here means that fluctuation in term of throughput of the plant does not essentially effect the quality of the polymer prepared, in particular polycarbonate prepared. The improvements with respect to polydispersity, flexibility and robustness each refer to a corresponding plant and process except that the reactor of the invention or the unit of the invention is not used.

The invention is further directed to a process for continuous production of a polymer in a plant, wherein the plant comprises a reactor according to the invention or the plant comprises a unit according to the invention as described above. The polymer to be produced is preferably a polyester, more preferably a polycarbonate. The process of the invention is a continuous process.

In a preferred embodiment of the inventive process, the process is a process for continuously producing a polycarbonate in the plant, wherein the reactor according to the invention or the first reactor according to unit of the invention is used as a pre-transesterification reactor, and the second reactor according to the unit of the invention which is connected with the pre-transesterification reactor is used as a first of at least two transesterification reactors. In this embodiment of the inventive process the plant comprises a mixing vessel, the pre-transesterification reactor as described above, the at least two transesterification reactors from which the first is the second reactor of the inventive unit as described above, at least one pre-polycondensation reactor and a final polycondensation reactor connected in series in this order. Moreover, in this embodiment, the inventive process comprises at least the following steps:
a) mixing a melt of one or more bisphenols with one or more diaryl carbonates in the mixing vessel to form a raw material melt,
b) adding one or more transesterification catalysts to the raw material melt, preferably after the raw material melt has left the mixing vessel, to form a raw material melt mixture containing the one or more transesterification catalysts,
c) pre-transesterifying the raw material melt mixture containing the one or more transesterification catalysts in the pre-transesterification reactor at a pressure of equal to or above 1 bar (a) to form a partially transesterified reaction mixture containing cleaved hydroxyaryl compound,
d) continuing transesterification of the formed partially transesterified reaction mixture in the at least two transesterification reactors at a pressure of below 1 bar (a) with continuous removal of cleaved hydroxyaryl compound to form a transesterified reaction mixture,
e) polycondensing the formed transesterified reaction mixture in the at least one pre-polycondensation reactor at a pressure of below 1 bar (a) with continuous removal of cleaved hydroxyaryl compound to form a pre-polycondensation product,
f) continuing the polycondensation of the formed pre-polycondensation product in the final polycondensation reactor at a pressure of below 1 bar (a) to form polycarbonate.

Usually, the transesterified reaction mixture mainly comprises monomers and monocarbonate, and the pre-polycondensation product mainly comprises oligomers.

The process steps a) to f) according to the above embodiment of the process of the invention and further general aspects of the production of polycarbonate are described below in detail. This embodiment of the process of the invention is designated as the “preferred process of the invention” or simply “preferred process”. As mentioned above, all aspects and features described also apply mutatis mutandis for the inventive reactor, the inventive unit and inventive use.

In general, the preferred process of the invention is a multi-stage continuous polycarbonate melting process, in which the raw materials, namely one or more bisphenols such as BPA and one or more diaryl carbonates such as DPC are converted into a low-molecular compound (monomer) by transesterification reaction and then into a high-molecular polymer by polycondensation reaction.

In the preferred process according to the invention, the polycarbonate production can be divided in four reaction steps from the starting substances bisphenol and diaryl carbonates, particularly a pre-transesterification reaction, a transesterification reaction, a pre-polycondensation reaction, and a polycondensation reaction.

The overall reaction which proceeds from bisphenol and diaryl carbonates to the production of polycarbonates is represented by the following equation, wherein R can be hydrogen or one or more substituents such as alkyl or aryl:

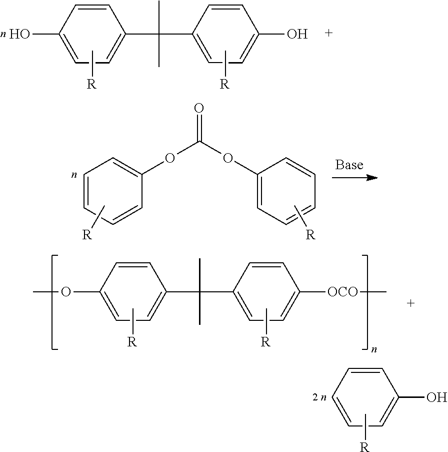

As can be seen from the above equation, a hydroxyaryl compound reaction product such as phenol is released by the reaction.

A transesterification reaction as exemplified by the reaction of bisphenol A with diphenyl carbonate is shown in the following equation:

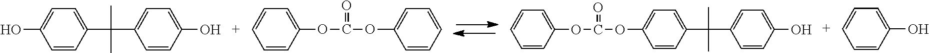 [SMILES: CC(C)(c1ccc(O)cc1)c1ccc(O)cc1 ; O=C(Oc1ccccc1)Oc1ccccc1 ; CC(C)(c1ccc(O)cc1)c1ccc(OC(=O)Oc2ccccc2)cc1 ; Oc1ccccc1]

The transesterification reaction is influenced by a number of parameters. The most important parameters are temperature, pressure, processing time, mole ratio of bisphenol and diaryl carbonate and the catalyst system used. As can be seen from the above equation, a hydroxyaryl compound such as phenol is cleaved by the reaction. During the transesterification, oligomerization may also occur to some extent.

The pre-polycondensation and polycondensation reaction are also influenced by a number of parameters. The most important parameters are reactive surface area, temperature, pressure and the catalyst system used. In contrast to the transesterification reaction, the processing time does not play a significant role in the polycondensation.

In step a) of the preferred process of the invention, a melt of one or more bisphenols is mixed with one or more diaryl carbonates in the mixing vessel to form a raw material melt.

The one or more bisphenols may be selected from any bisphenols and are preferably dihydroxy-diarylalkanes with the formula HO—Z—OH, wherein Z is a divalent organic moiety with 6 to 30 carbon atoms, which contains one or more aromatic groups. The one or more diaryl carbonates may be selected from any diaryl carbonates and are preferably a di-(C₆ to C₁₄-aryl) carbonic acid ester.

In a particular preferred embodiment, the bisphenol is or comprises bisphenol A (BPA) and the diaryl carbonate is or comprises diphenyl carbonate (DPC). In this case, the cleaved hydroxyaryl compound reaction product is phenol.

The one or more bisphenols, in particular BPA, and the one or more diaryl carbonates, in particular DPC, are preferably mixed in a molar ratio of bisphenol to diaryl carbonate of 1.0 to 1.20, more preferably in a molar ratio of 1.03 to 1.15, still more preferably 1.05 to 1.10.

It is preferred that the one or more bisphenols such as BPA in solid form (so-called flakes or prills) are melted and then continuously mixed with liquid DPC in the mixing vessel at a sufficient temperature in a defined molar ratio to form the so-called “raw material melt”. This raw material melt is then continuously fed into the pre-transesterification reactor, wherein beforehand one or more transesterification catalysts are added according to step b) described below at a suitable position.

In step b) of the preferred process of the invention, one or more transesterification catalysts are added to the raw material melt to form a raw material melt mixture, preferably after the raw material melt has left the mixing vessel.

The one or more transesterification catalysts can be added to the raw material melt to form a raw material melt mixture at any position, e.g., the one or more transesterification catalysts can be added to the mixing vessel. The one or more transesterification catalysts can be added to the bisphenol and the diaryl carbonate raw materials in any desired order.

It is preferred that one or more transesterification catalysts are added to the raw material melt after the raw material melt has left the mixing vessel to form the raw material melt mixture, in particular the one or more transesterification catalysts are added to the raw material melt before it enters the pre-transesterification reactor. Thus, the one or more transesterification catalysts are generally added to the raw material melt in the connecting pipe between the mixture vessel and the pre-transesterification reactor, through which the raw material melt flows. It may be suitable to implement a mixing device in the connecting pipe after the addition point for the one or more transesterification catalysts to improve mixing.

The raw material melt mixture, i.e., the raw material melt to which the one or more transesterification catalysts have been added, is then fed into the pre-transesterification reactor.

In step c) of the preferred process of the invention, the raw material melt mixture is pre-transesterified in the pre-transesterification reactor at a pressure of equal to or above 1 bar (a) to form a partially transesterified reaction mixture.

The pre-transesterification reactor is the reactor of the invention or the first reactor of the unit of the invention which has been discussed above in detail. All aspects and features related thereto and discussed above equally apply to the process of the invention so that reference is made thereto.

The pre-transesterification in the pre-transesterification reactor is preferably carried out at a temperature in the range of 175 to 205° C., more preferably from 180 to 200° C., still more preferably from 185 to 195° C., and/or a pressure in the range of 5 to 1 bar (a), more preferably from 5 to 1.1 bar (a), still more preferably from 3.5 to 1.5 bar (a), and most preferably from 3 to 2 bar (a).

The pre-transesterification of the raw material melt mixture preferably leads to a bisphenol transesterification degree in the partially transesterified reaction mixture leaving the pre-transesterification reactor in the range of 65% to 90%, preferably 75% to 85% and more preferably 79% to 83%, wherein the bisphenol is preferably BPA.

The bisphenol transesterification degree refers to the percentage of bisphenol used as raw material which has been reacted with the diaryl carbonate. For instance, a bisphenol transesterification degree of 80% means that 0.8 mol of bisphenol of 1 mol feed bisphenol has reacted with diaryl carbonate.

As discussed above, a hydroxyaryl compound such as phenol is cleaved by the transesterification. Because of the conditions in the pre-transesterification reactor, the cleaved hydroxyaryl compound is retained in the reaction mixture. The pre-transesterification is carried out at a pressure of equal to or above 1 bar (a). The pre-transesterification reactor is generally not provided with an outlet for removal of the cleaved hydroxyaryl compound from the reaction mixture.

The partially transesterified reaction mixture formed in the pre-transesterification reactor is fed to the first of the at least two transesterification reactors via one or more connecting pipes. The state of the reaction mixture is saturated. The composition of the partially transesterified reaction mixture (saturated monomer melt) consists mainly of
still unreacted raw materials bisphenol such as bisphenol-A (BPA) and diarylcarbonate such as diphenyl carbonate (DPC), and
hydroxyaryl compound such as phenol cleaved by the pre-transesterification reaction of BPA with DPC, and
transesterification products or monomers obtained by transesterification reaction, here called monocarbonate (MC).

In step d) of the preferred process of the invention, transesterification of the formed partially transesterified reaction mixture is continued in the at least two transesterification reactors at a pressure of below 1 bar (a) with continuous removal of cleaved hydroxyaryl compound to form a transesterified reaction mixture. The first of the at least two transesterification reactors may be the second reactor of the unit of the invention which has been discussed above in detail. All aspects and features related thereto and discussed above equally apply to the process of the invention so that reference is made thereto.

As discussed above, at least one pressure regulating valves is provided at vapor lines connected to the transesterification reactors and/or connecting pipes to cope with the pressure difference between the pre-transesterification reactor and the first transesterification reactor. This generally applies to all reactors connected with each other via connecting pipes when there is a pressure difference between them.

The at least two transesterification reactors are preferably two or three transesterification reactors more preferably three transesterification reactors, in a production line.

The continued transesterification in the at least two transesterification reactors is preferably carried out at a temperature in the range of 180 to 250° C., preferably 180 to 230° C., and/or at a pressure of 0.5 to 0.05 bar (a), preferably 0.5 to 0.1 bar (a).

The temperature and pressure conditions mentioned above apply independently for the at least two transesterification reactors. That is, temperature and pressure conditions may vary in the at least two transesterification reactors within these ranges. In general, it is preferred that in the at least two transesterification reactors the temperature is constant or increases, preferably increases from reactor to reactor in the downstream direction and/or the pressure is constant or decreases, preferably decreases, from reactor to reactor in the downstream direction.

The bisphenol transesterification degree in the transesterified reaction mixture leaving the last of the at least two transesterification reactors is preferably at least 95%, more preferably at least 97% and still more preferably at least 99%.

The at least two transesterification reactors are preferably stirred-tank reactors. The transesterification reactors, preferably stirred-tank reactors, are typically configured with internal and/or external heating means such as internal heat coils and/or external jacket heater.

The at least two transesterification reactors are connected in series. The partially transesterified reaction mixture from the pre-transesterification reactor enters the first of the at least two transesterification reactor and is fed through the following one or more transesterification reactors for continuing transesterification.

As discussed above, the first transesterification reactor (the second reactor of the inventive unit) is configured such that flash evaporation, preferably controlled flash evaporation, and removal of the by-products such as hydroxyaryl compounds such as phenol contained in the partially transesterified reaction mixture from the pre-transesterification reactor entering the first transesterification reactor can be achieved. In a preferred embodiment, the first transesterification reactor is provided with overflow means such as an overflow balcony so that the partially transesterified reaction mixture can be introduced into the first transesterification reactor in form of a falling film facilitating evaporation of residual by-products such as hydroxyaryl compounds such as phenol in the partially transesterified reaction mixture remaining after flash evaporation. Reference is made to the detailed discussion in this regard with respect to the above description of the inventive unit.

In general, hydroxyaryl compounds such as phenol cleaved in the transesterification in the at least two transesterification reactors are continuously removed from the at least two transesterification reactors. Because of the temperature and pressure conditions (vacuum) in the at least two transesterification reactors, the cleaved hydroxyaryl compounds such as phenol enters the vapor phase. The vapor phase of the at least two transesterification reactors may contain other volatile compounds such as DPC vapors which are also removed.

The at least two transesterification reactors are connected with means such as distillation columns or process columns, respectively, for removal of the hydroxyaryl compounds such as phenol and optionally possible other volatile compounds for separation.

An additional DPC purification (or DPC recovery column, or bleed column), is connected to the previous process column, more preferably connected to the bottom's outlet stream of the process column, which is connected to the at least two transesterification reactors.

This additional DPC purification (or DPC recovery column, or bleed column) is foreseen to receive the bottoms outlet stream of the previous process column as feed-stream, and then to separate this feed stream, which means the separation of the diarylcarbonate such as diphenyl carbonate, and/or the hydroxyaryl compounds such as phenol and optionally possible other volatile compounds and heavy-boiling compounds (heavies) for separation.

The additional DPC purification (or DPC recovery column, or bleed column) has three outlets, 1) one column bottoms product outlet, 2) one column head product outlet and 3) one column middle section outlet.

The additional DPC purification (or DPC recovery column, or bleed column), is separating 1) the heavy-boiling components as the bottom product (such as phenyl-hydroxy-4-benzoates, 4,4-dihydroxy-benzophenones and other heavy boilers) and further called heavy bleeds, from the diaryl carbonate such as diphenyl carbonate. The bottom part of the additional DPC purification (or DPC recovery column, or bleed column), is equipped with an external reboiler or an internal heating coil, for providing the required heat for boiling of the bottom product. The bottom part of the additional process column is connected to a pump for a) discharging (bleeding-off) the bottom product, and b) an internal recirculation means to the additional DPC purification (or DPC recovery column, or bleed column) for consistent liquid phase intermixing rate, thus enabling a permanent liquid phase exchange at the internal heat exchanger hot coil surfaces.

The additional DPC purification (or DPC recovery column, or bleed column), is separating 2) the volatile hydroxyaryl compounds such as phenol, low-volatile benzoates or salicylates, and further called light bleeds as head product, from the diaryl carbonate such as diphenyl carbonate. The head product outlet stream of the bleed column is connected to a condensation system, for condensation means of these light bleeds in liquid phase.

The additional DPC purification (or DPC recovery column, or bleed column), is therefore purifying 3) the remaining diaryl carbonate such as diphenyl carbonate. The medium part or middle section of the additional DPC purification (or DPC recovery column, or bleed column), is connected to a collecting system, for collecting means of recovered/purified diaryl carbonate such as diphenyl carbonate. The vessel, which is connected to the collecting system, is connected to a pump for internal recirculation means to the medium part of the additional DPC purification (or DPC recovery column, or bleed column), and/or for internal recirculation of the collecting system, and/or for transferring the recovered and purified diaryl carbonate such as diphenyl carbonate to the raw material storage and supply with its unloading, conveying, mixing and feeding equipment of the raw materials such as BPA and DPC.

The transesterified reaction mixture leaving the last of the at least two transesterification reactors is fed to the first of the at least one pre-polycondensation reactor via one or more connecting pipes.

In step e) of the preferred process of the invention, the transesterified reaction mixture formed in the at least two esterification reactors is polycondensed in the at least one pre-polycondensation reactor at a pressure of below 1 bar (a) with continuous removal of cleaved hydroxyaryl compound to form a pre-polycondensation product. The pre-polycondensation forms oligomer chains, and oligomer chains which have already been formed react with each other to form longer polymer chains. Parallel to this chain extension reaction, there are also chain breaking reactions which halt the growth of the chain lengths.

The polycondensation in the at least one pre-polycondensation reactor is preferably carried out at a temperature in the range of 235 to 290° C., preferably 250 to 280° C., and/or a pressure of 30 to 2.5 mbar (a), preferably 20 to 2.5 mbar (a).

The temperature and pressure conditions mentioned above apply independently for the at least one pre-polycondensation reactor. That is, temperature and pressure conditions may vary in the at least one pre-polycondensation reactor within these ranges. In general, it is preferred that in the case that more than one pre-polycondensation reactor is present, such as two pre-polycondensation reactors, the temperature is constant or increases, preferably increases from reactor to reactor in the downstream direction and/or the pressure is constant or decreases, preferably decreases, from reactor to reactor in the downstream direction.

In a preferred embodiment, the at least one pre-polycondensation reactor is a stirred-tank reactor and, if present, a subsequent pre-polycondensation reactor is a horizontal agitated reactor. The at least one pre-polycondensation reactor is typically configured with internal and/or external heating means such as internal heat coils and/or external jacket heater.

In a preferred embodiment, the at least one pre-polycondensation reactor are two pre-polycondensation reactors in a production line.

The transesterified reaction mixture from the last transesterification reactor enters the first of the at least one pre-polycondensation reactor and is fed through the following one or more pre-polycondensation reactors, if present, for continuing polycondensation. If more than one pre-polycondensation reactor is used, they are usually connected in series in a production line.

Hydroxyaryl compounds such as phenol cleaved in the polycondensation in the at least one pre-polycondensation reactor are continuously removed from the at least one pre-polycondensation reactor. Because of the temperature and pressure conditions in the at least one pre-polycondensation reactor, the cleaved hydroxyaryl compounds such as phenol enters the vapor phase. The vapor phase of the at least one pre-polycondensation reactor may contain other volatile compounds which are also removed.

The at least one pre-polycondensation reactor is connected with means such as distillation columns, process columns, double condenser, scraper condenser or spray condenser, for removal of the hydroxyaryl compounds such as phenol and possible other volatile compounds, respectively. Phenol and DPC released during the pre-polycondensation reaction, as well as entrained oligomer, are preferably separated in a double condenser. For instance, hydroxyaryl compound such as phenol and DPC released during the pre-polycondensation reaction, as well as entrained oligomer, are preferably separated in a double condenser as is described in WO 2013/189823. Another example is a spray condenser for a first pre-polycondensation reactor and a scraper condenser for the second pre-polycondensation reactor.

The pre-polycondensation product leaving the last of the at least one pre-polycondensation reactor is fed to the final polycondensation reactor via one or more connecting pipes.

In step f) of the preferred process of the invention, the polycondensation of the pre-polycondensation product formed in the at least one pre-polycondensation reactor is continued in the final polycondensation reactor at a pressure of below 1 bar (a) to form polycarbonate. The final polycondensation reactor is also called finisher.

The continued polycondensation in the final polycondensation reactor is preferably carried out at a temperature in the range of 280 to 320° C., preferably 290 to 310° C., and/or a pressure of 2 to 0.25 mbar (a), preferably 1.25 to 0.25 mbar (a).

The final polycondensation reactor is preferably a horizontal agitated reactor.

Cleaved hydroxylauryl compounds such as phenol are usually also continuously removed during polycondensation in the final polycondensation reactor. Accordingly, the final polycondensation reactor is usually connected with means for removal of the hydroxyaryl compounds such as phenol and possible other volatile compounds such as a scraper condenser or a process condenser.

A heat exchanger, which is preferably a tube-bundle heater, and/or more preferably a plate-type heat exchanger and/or most preferably a prepolymer melt heat exchanger with mixing elements and/or heating elements, is connected upstream the inlet line of the final polycondensation reactor. The heat exchanger with mixing elements enables a higher heat transfer value (k-value) and therefore a smaller heat exchange surface.

The prepolymer melt heat exchanger is providing heat to the prepolymer melt which is fed into the final polycondensation reactor. This provides an additional possibility for regulating and/or covering the heat and/or heat losses inside the final polycondensation reactor occurring by cleaving of the hydroxyaryl compounds such as phenol and possible other volatile compounds and/or decreasing the heat demand of the final polycondensation reactor internal heating and/or external heating elements.

Furthermore, thermal degradation of the polymer inside the final polycondensation reactor can be avoided by the polymer melt heat exchanger, by increasing the temperature of the prepolymer stream, decreasing the dwell time inside the final polycondensation reactor and decreasing the contact temperature difference between the final polycondensation reactors internal heating and/or external heating elements with the polymer.

The final polycondensation takes place continuously in at final polycondensation reactor in which the polymer mass is exposed to an increased temperature (preferably 280-320, more preferably 290-310° C.) and reduced pressure (preferably 2-0.25 mbar (a), more preferably 1.25-0.25 mbar (a)) during the entire process. It is preferred that the final polycondensation reactor is configured to provide an increased film evaporation area, for example through special stirring devices, as is common in this technical field. Due to these conditions, the molecular growth reaction is strongly accelerated, resulting in a polymer melt with a high molecular weight and high viscosity.

The polycarbonate formed in the polycondensation reactor (finisher) typically has a mean chain length of about 60 to 200 monomer units, and particularly about 65 to 150 monomer units, and/or a weight average molecular weight (Mw) in the range of about 16,000 to 38,000.

In the following, examples and further details for the materials used such as in the raw material melt mixture are given with respect to the invention in general, i.e. the reactor, the unit, the use and the process of the invention.

The one or more transesterification catalysts used in the present invention can be any of those transesterification catalysts which are typically used in this technical field. The transesterification catalyst can be added in form of a solution of the transesterification catalyst in a solvent.

The transesterification catalyst is preferably selected from the group consisting of quaternary ammonium salts, in particular quaternary ammonium hydroxides, quaternary phosphonium salts, or a mixture thereof such as a quaternary ammonium salt, in particular a quaternary ammonium hydroxide, and a quaternary phosphonium salt.

The one or more transesterification catalysts are preferably added in such an amount that the total concentration thereof, based on the mass of the polycarbonate prepared, is 10 to 1000, preferably 25 to 250, more preferably 50 to 150 ppm (by mass).

Quaternary ammonium salts preferably have the general structure [(R)₄—N]⁺[X]⁻, wherein R represents independently of each other alkyl and/or aryl groups, and X⁻ represents inorganic or organic anions, in particular selected from hydroxide, sulphate, carbonate, formate, benzoate, or phenolate. Examples of quaternary ammonium salts suitable for the present invention are tetramethylammonium hydroxide, tetraethylammonium hydroxide, tetrabutylammonium hydroxide, tetramethylammonium formate, tetraethylammonium formate, tetrabutylammonium formate, tetramethylammonium acetate, tetraethylammonium acetate, tetrabutylammonium acetate, tetramethylammonium fluoride, tetraethylammonium fluoride, tetrabutylammonium fluoride or a mixture thereof. Quaternary ammonium hydroxides are preferred, in particular tetramethylammonium hydroxide or tetraethylammonium hydroxide.

Quaternary phosphonium salts preferably have the general structure [(R)₄-P]⁺[X]⁻, wherein R represents independently of each other alkyl and/or aryl groups, and X⁻ represents inorganic or organic anions, in particular selected from hydroxide, sulfate, carbonate, formate, benzoate, phenolate. Examples of quaternary phosphonium salts suitable for the present invention are tetramethylphosphonium hydroxide, tetramethylphosphonium formate, tetramethylphosphonium acetate, tetramethylphosphonium benzoate, tetraethylphosphonium hydroxide, tetraethylphosphonium formate, tetraethylphosphonium acetate, tetraethylphosphonium benzoate, tetrabutylphosphonium hydroxide, tetrabutylphosphonium acetate, tetrabutylphosphonium benzoate, tetraphenylphosphonium hydroxide, tetraphenylphosphonium acetate, tetraphenylphosphonium phenolate, tetrabutylphosphonium acetate, tetramethylphosphonium tetraphenylborohydride, tetraphenylphosphonium bromide, tetraphenylphosphonium tetraphenylboranate, tetra (p-tert-butylphenyl)phosphonium diphenyl phosphate, triphenylbutylphosphonium phenolate, triphenylbutylphosphonium tetraphenylboranate, tetraphenylphosphonium chloride, tetraphenylphosphonium fluoride or a mixture thereof.

The transesterification catalyst is preferably selected from quaternary phosphonium salts, tetramethylammoniumhydroxide, tetraethylammoniumhydroxide or a mixture thereof.

The one or more transesterification catalysts are usually added to the raw material melt, wherein the one or more transesterification catalysts are preferably added before the reactor of the invention such as the pre-transesterification reactor. Optionally, additional one or more transesterification catalysts may be added after the pre-transesterification reactor, i.e. the inventive reactor, and before the first transesterification reactor, i.e. the second reactor of the inventive unit, to the reaction mixture stream.

Typically, one or more polycondensation catalysts are added to the reaction mixture stream. The reaction mixture stream refers to the reaction material and respective reaction material stream flowing through the reactors used in the present invention and the connecting pipes between these reactors. The one or more polycondensation catalysts can be added together or separately at one or more suitable positions of the inventive process. The one or more polycondensation catalysts may be added into one or more of the reactors and/or at one or more position in a connecting pipe between the reactors. The one or more polycondensation catalysts can be added in form of a solution in a solvent.

The one or more polycondensation catalysts are preferably added in such an amount that the total concentration thereof, based on the mass of the polycarbonate prepared, is 0.5 to 20, preferably 1 to 10, more preferably 2 to 5 ppm (by mass).

In a preferred embodiment, the one or more polycondensation catalysts are added after the pre-transesterification reactor and before entering the final polycondensation reactor, or preferably after the first transesterification reactor and before entering the last pre-polycondensation reactor, or more preferably in and/or after the last transesterification reactor and before entering the first pre-polycondensation reactor.

The one or more polycondensation catalysts used in the present invention can be any polycondensation catalyst known. Examples are alkali metal compounds such as alkali metal hydroxide alkali metal oxides, alkali metal carboxylates, alkali metal salts of organic and inorganic acids, alkaline earth hydroxides, alkaline earth oxides, and quaternary phosphonium salts or a mixture thereof.

The one or more polycondensation catalysts are preferably selected from the group consisting of alkali hydroxides, alkaline earth hydroxides, alkali oxides, alkaline earth oxides, quaternary phosphonium salts, or a mixture thereof.

Examples of alkali hydroxides, alkaline earth hydroxides, alkali oxides, and alkaline earth oxides suitable for the present invention are sodium hydroxide, potassium hydroxide and lithium hydroxide. Examples of quaternary phosphonium salts are same as those indicated as transesterification catalysts so that reference is made thereto.

In general, the plant is provided with means to remove vaporous hydroxylaryl compounds such as phenol released by the transesterification and chain growth from the reactors by means of a vacuum system which may include a process steam condensation stage, vacuum jet systems and vacuum pumps.

The ratio of OH terminal groups/aryl carbonate terminal group in the reaction mixture is a further parameter influencing the quality of the polycarbonate produced. Variation may occur by slight variations in the starting stoichiometry of the bisphenols and diaryl carbonates used or more importantly by distillation losses of the diaryl carbonate during the removal of the hydroxylaryl compounds during the process. Thus, additional diaryl carbonate may be added to the reaction mixture streams, e.g. in the first transesterification reactor for the purpose of adjusting the desired OH/aryl carbonate terminal group ratio.

The process of the invention can be carried out in a plant including a single production line or two or more parallel production lines. In case of two or more parallel production lines, the plant is configured such that before at least one of the at least one pre-polycondensation reactor the production line or the reaction mixture stream, respectively, is split into at least two parallel production lines or reaction mixture streams, respectively. In a preferred embodiment for the case of two or more parallel production lines, the plant is designed in such a way that, after the first of the at least one pre-polycondensation reactors, the production line or the reaction mixture stream is split into at least two parallel production lines. The configuration of each parallel production line after the split is analogous with respect to the general process steps and the type, number and connection of the respective reactors.

For all configurations, at least the mixing vessel, the pre-transesterification reactor, and the at least two transesterification reactors are preferably connected in series in this order. Thereafter the reaction mixture stream may be split one or more times to generate two or more parallel production lines.

For each of the parallel production lines, the common reactors and process steps before each split are considered to be part of the respective parallel production line. For instance, if two parallel production lines are designed by splitting the production line or reaction mixture stream, respectively, after the first pre-condensation reactor, and feeding one split reaction mixture stream to a second pre-condensation reactor of a first production line and the other split reaction mixture stream to a second pre-condensation reactor of a second production line, the joint first pre-condensation reactor is considered to be part of both the first production line and the second production line.

The benefit of parallel production lines is that a higher throughput is possible and/or polycarbonates of different quality can be produced at the same time. The variation can be achieved, for instance, by using different parameters for the process steps within the ranges recited above and/or using different types and/or amounts of condensation catalysts and/or adding different types and/or amount of additives.

Hence, according to a preferred embodiment, the process is carried out i) in a production line or a single production line wherein the mixing vessel, the pre-transesterification reactor, the at least two transesterification reactors, the at least one pre-polycondensation reactor and the final polycondensation reactor are connected in series in this order.

According to an alternative preferred embodiment the process is carried out ii) in at least two parallel production lines by splitting the reaction mixture stream or the production line, respectively, before at least one of the at least one pre-polycondensation reactor into at least two parallel production lines wherein, considering the common reactors before each split, in each of the parallel production lines the mixing vessel, the pre-transesterification reactor, the at least two transesterification reactors, at least one pre-polycondensation reactor and a final polycondensation reactor are connected in series in this order.

According to a preferred embodiment, the process is carried out in single production line according to the configuration i) discussed above, see also FIG. 7A. Preferred embodiments including parallel production lines are described below in FIG. 7B-D.

In general, also in case of parallel production lines, the mixing vessel, the pre-transesterification reactor, and the at least two transesterification reactors, preferably two transesterification reactors and more preferably three transesterification reactors, are connected in series in this order. In case of parallel production lines, if a split is effected only after the first pre-polycondensation reactor, the mixing vessel, the pre-transesterification reactor, the at least two transesterification reactors, preferably two transesterification reactors and more preferably three transesterification reactors, and the first of the at least one pre-polycondensation reactor are connected in series in this order.

In case of parallel production lines, preferred configurations include a split of the reaction mixture stream after the first pre-polycondensation reactor into two or more, preferably two or three, reaction mixture streams or parallel production lines, respectively, each of which include the at least one further pre-polycondensation reactor, preferably only one further pre-polycondensation reactor, and the final polycondensation reactor, connected in series in this order.

In further preferred configurations, the plant includes a split of the reaction mixture stream after the last transesterification reactor into two or three, preferably two, reaction mixture streams or parallel production lines, respectively, each of which include a first pre-polycondensation reactor and a further split of the reaction mixture stream after the first pre-polycondensation reactor in each of the parallel production lines, into two or three, preferably three, reaction mixture streams or parallel production lines, each of which contain a second pre-polycondensation reactor and the final polycondensation reactor, connected in series in this order.

In general, the produced polycarbonate leaving the final polycondensation reactor is typically subjected to further processing or finishing steps.

Thus, in a preferred embodiment the process of the invention may further comprise the following steps:
g) feeding or distributing the formed polycarbonate leaving the final polycondensation reactor to one or more melt extruders in which independently from each other one or more additives are added to the melted polycarbonate, wherein the formed polycarbonate is preferably pre-filtrated before entering the one or more melt extruders, and
h) pelletizing the polycarbonate mixed with the one or more additives in one or more pelletizing units to obtain polycarbonate in granular form such as chips or pellets,
   wherein the melted polycarbonate mixed with the one or more additives is optionally or preferably filtered in a filtration unit before entering the pelletizing unit.

Specifically, after the polycarbonate has been produced as a polymer melt, a number of special additives can be continuously mixed into it via an extruder system, in particular a twin screw extruder to produce special polycarbonate types and the subsequent desired material properties.

Finally, the polymer melt is usually filtered once or several times through filter systems on its way to the pelletizing unit. Then one or more pelletizing units can be employed, which uses strand casting heads and one or more chip-water circulation and cooling systems to transport and solidify the strands to the cutting head, cuts the strands into the desired size and produces the finished granulate such as pellets or chips, which are then further cooled and dried. The granules (polycarbonate chips or pellets) are then separated from oversized particles by means of a special vibrating conveyor screening machine.

The finished polycarbonate granulate is usually pneumatically conveyed to silos or silo mixing unit for intermediate storage and quality testing. From there, the polycarbonate granulate is then fed to packaging stations, filled and stored for sale.

The polycarbonate obtained by the process of the invention has preferably a polydispersity value of 3 or less, more preferably ≤2.7, more preferably ≤2.6, as determined by size exclusion chromatography according to DIN EN ISO 16014-5:2019-09. It is also preferred that the polycarbonate has a low polymer cross-linking (gel nodules) content. Moreover, the polycarbonate obtained preferably has a high mechanical impact strength.

The invention is further illustrated by the accompanying drawings and examples described below. The drawings and examples provided are provided for illustration purposes only and are by no way intended to limit the scope of the present invention. The same reference signs are used throughout the drawings. FIG. 1 shows a process scheme of the initial phase of a melt transesterification process used by the applicant with BPA and DPC as exemplary raw materials not according to the invention. In the first phase according to FIG. 1, the raw materials BPA and DPC are continuously fed to the mixing vessel MV in liquid form and in a defined molar ratio mol DPC/mol BPA. The mixing vessel MV is operated at atmospheric pressure. The thus mixed raw material melt is continuously fed to the first transesterification reactor TE1 via pump DP. On its way there, the raw material melt is preheated by approx. 30-40° C. via the pre-heater PH using liquid heat transfer oil (HTM). Before the raw material melt enters the first transesterification reactor TE1, the transesterification catalyst TCAT is continuously added in the desired proportion and mixed with both raw materials by a mixing device SM to obtain a raw material melt mixture. The transesterification catalyst TCAT is added in form of a solution in a solvent.

Thus, the pre-heated raw material melt is supplied with the transesterification catalyst shortly before entrance into the first transesterification reactor. The raw material melt mixture is fed into the first transesterification reactor at a position below the level of the reaction mixture in the first transesterification reactor.

The reaction in the first transesterification reactor and the following reaction stages of the overall polycarbonate production process can be as described in Reference example 1.

FIG. 2 shows a modified process scheme of the initial phase of a melt transesterification process used by the applicant with BPA and DPC as exemplary raw materials based on the first phase according to the FIG. 1 which is also not according to the invention. The modification is a change of the position of the addition of the transesterification catalyst TCAT. That is, in the modified process scheme of FIG. 2 the transesterification catalyst TCAT is added to the mixture of raw materials BPA and DPC and mixed using a mixing device SM before entering the mixing vessel MV so that transesterification catalyst TCAT is already included in the mixture included in the mixing vessel MV. As to the other components, the process scheme essentially corresponds to that of FIG. 1 so that reference is made thereto. Thus, in this case, the raw material mixing tank acts as a so-called pre-reactor. Using pump DP, the pre-reacted raw material melt mixture is then fed via a mixing device SM and a preheater PH to the first transesterification reactor TE1. The preheater PH is heated by liquid heat transfer oil (HTM).

FIG. 3 shows a schematic side view of a preferred example of the reactor of the invention corresponding to the first reaction of the inventive unit which is preferably used as a pre-transesterification reactor. The inventive reactor is a vertical reactor. The reactor is provided on the downstream side with an inlet IN for the entering feed of the raw material melt mixture and on the upstream side with an outlet OUT for the flowing out feed of the reacted raw material melt mixture, preferably a partially transesterified reaction mixture.

The reactor is designed with a lower heating zone HZ and a reaction chamber or reaction zone RZ above it. The heating zone HZ is in form of a heat exchanger section, in particular a tube-bundle heater. The reaction zone RZ includes a mixing device, in particular at least one integrated static mixer (not shown). The mixing device provides sufficient mixing quality for edge flow exchange. The reaction zone is equipped with a heating device such as a heating jacket or heating coil or external heat exchanger to maintain the desired reaction temperature in the reaction zone.

During operation, the reactor can be operated such that the reaction zone is always filled with the raw material melt mixture or monomer melt, flowing through the reactor. Typically, the heating zone is also always filled with the raw material melt mixture and flowed through by it.

Moreover, the reactor can be operated with a short dwell time of the raw material melt mixture in the reaction chamber such as with a dwell time of as short as 4-5 minutes.

The reactor does not include outlets for removing hydroxyl compounds such as phenol from the reaction mixture.

The reactor according to FIG. 3 is used in Example 2 and corresponds to the pre-transesterification reactor shown in FIG. 4.

FIG. 4 shows a process scheme of a melt transesterification process as part of the process for the preparation of polycarbonate according to the invention with BPA and DPC as exemplary raw materials. In the first phase according to the process of FIG. 4, the raw materials BPA and DPC are mixed using a mixing device SM and continuously fed to the mixing vessel MV in liquid form and in a defined molar ratio mol DPC/mol BPA. The thus mixed raw material melt is continuously fed to the mixing vessel MV. The mixing vessel MV is operated under vacuum for venting volatile impurities. The raw material melt is fed from the mixing vessel MV using a discharge pump DP to the pre-transesterification reactor PTR. Before the raw material melt enters the pre-transesterification reactor PTR, the transesterification catalyst TCAT in form of a solution is continuously added to the raw material melt in the desired ratio to obtain a raw material melt mixture. In the connecting pipe a mixing device SM is implemented to achieve homogenous mixture of transesterification catalyst TCAT and raw material melt. Finally, the raw material melt mixture including the transesterification catalyst TCAT enters the pre-transesterification reactor PTR.

The pre-transesterification reactor PTR which is the reactor according to the invention is provided with a heating zone in form of a tube-bundle heater and a reaction zone upstream of the heating zone and including integrated static mixer. For further details of the pre-transesterification reactor PTR see FIG. 3 and the description related thereto.

The raw material melt mixture enters the heating zone of the pre-transesterification reactor PTR flowing through the tubes of a tube-bundle heater whereby it is heated to a predetermined temperature. Then the heated raw material melt mixture flows into the reaction zone where the pre-transesterification reaction takes place. The reaction chamber is completely filled with the reaction mixture during operation. The reaction conditions in the reaction zone are typically a temperature in the range of 175 to 205° C., preferably from 180 to 200° C., more preferably from 185 to 195° C., and a pressure in the range of 5 to 1 bar (a), preferably from 5 to 1.1 bar (a), more preferably from 3.5 to 1.5 bar (a), more preferably from 3 to 2 bar (a).

The pre-transesterified reaction mixture flowing out the pre-transesterification reactor PTR at the outlet is continuously fed to the first transesterification reactor TE1′. The first transesterification reactor TE1′ is a preferred example of the second reactor of the inventive unit. Hence, process scheme of FIG. 4 shows the inventive unit including the first and the second reactors implemented in a plant for the continuous production of polycarbonate.

The first transesterification reactor TE1′ is provided with three input nozzles N1/N2/N3 which are not visible in this view (cf. FIG. 5). The pre-transesterified reaction mixture from the pre-transesterification reactor enters the first transesterification reactor via these inlet nozzles above the level of the reaction mixture in this reactor. The first transesterification reactor TE1′ is a stirred tank reactor provided with internal heating means such as internal heating coils. The first transesterification reactor TE1′ works under vacuum and is connected with means for removing cleaved phenol in the vapor phase such as a process column.

The first transesterification reactor TE1′ be operated at a temperature in the range of 200180 to 250° C., preferably 180 to 230° C., and a pressure of 0.5 to 0.05 bar (a), preferably 0.5 to 0.1 bar (a).

Due to the pressure difference between the inlet pressure (pre-transesterification reactor) and the first transesterification reactor TE1′ flash evaporation and removal of the by-products such as phenol in the entering partially transesterified reaction mixture can be achieved. A pressure control PC such as a pressure control valve implemented in a connected vacuum line can be used to control the flash evaporation.

Moreover, the first transesterification reactor TE1′ is provided with an overflow balcony at a top portion within the transesterification reactor and over the level of the reaction mixture in the transesterification reactor. The overflow balcony is described in more detail in FIG. 5. The pre-transesterified reaction mixture is fed to the overflow balcony and overflows to form a falling film. This enables effective and maximum further evaporation of the residual phenol included in the pre-transesterified reaction mixture after controlled flash evaporation.

In the first transesterification reactor TE1′ the first stage of continued transesterification takes place. The reaction mixture from the first transesterification reactor TE1′ is continuously fed to the second transesterification reactor (not shown). Apart from that, the process further including transesterification, pre-polycondensation and final polycondensation is carried out analogous to the process steps as described in Reference Example 1.

The heating operations are generally effected by means of a liquid heat transfer oil (HTM).

FIG. 5 is a top view of the first transesterification reactor TE1′ of FIG. 4 at the plane of the overflow balcony. The overflow balcony is provided with three inlet nozzles through which the pre-transesterified reaction mixture enters the transesterification reactor TE1′. The nozzles are placed on the same height level, tangentially distributed around the overflow balcony.

FIG. 6 is a graph showing the reaction behavior and transesterification degree as the result of pre-transesterification test with respect to transesterification according to Reference example 2.

FIG. 7A-D show process block diagrams of preferred process and unit configurations of the invention including one production line or at least two parallel production lines. In these drawings, the mixing vessel preceding the pre-transesterification reactor has been omitted for simplification. Since in configurations with parallel production lines the temperature and pressure conditions within the specified ranges as well as type and amounts of added components such as catalysts may be varied in the reactors following the split, production of polycarbonate with differing properties can be produced at the same time. The pre-transesterification reactor (pre-TE reactor) is the inventive reactor of first reactor of the inventive unit. The first transesterification reactor TE1 is the second reactor of the inventive unit.

FIG. 7A shows a process block diagram of a preferred process and unit or plant configuration of the invention including a single production line. In this configuration the process is carried out in a production line comprising a pre-transesterification reactor (pre-TE reactor), three transesterification reactors (TE1, TE2, TE3), two pre-polycondensation reactors (PP1, PP2) and a final polycondensation reactor (finisher) which are connected in series in this order. With this unit/plant configuration a polycarbonate production of up to 90 kta is possible at present.

FIG. 7B shows a process block diagram of a preferred process and unit or plant configuration of the invention including two parallel production lines. In this configuration the process is carried out in a production line comprising a pre-transesterification reactor (pre-TE reactor), three transesterification reactors (TE1, TE2, TE3), and one pre-polycondensation reactor (PP1) which are connected in series in this order. After the first pre-polycondensation reactor (PP1) the reaction mixture stream or production line is split into two reaction mixture streams or parallel production lines, respectively, each of which subsequently comprises a second pre-polycondensation reactor (PP2) and a final polycondensation reactor (finisher) which are connected in series in this order.

Since each shared reactor before each split is considered for each of the respective parallel production lines, each parallel production line includes the same number, type and order of the reactors as the single production line according to FIG. 7A. With this unit or plant configuration a polycarbonate production of up to 180 kta is possible at present.

FIG. 7C shows a process block diagram of a preferred process and unit or plant configuration of the invention including three parallel production lines. In this configuration the process is carried out in a production line comprising a pre-transesterification reactor (pre-TE reactor), three transesterification reactors (TE1, TE2, TE3), and one pre-polycondensation reactor (PP1) which are connected in series in this order. After the first pre-polycondensation reactor (PP1) the reaction mixture stream or the production line is split into three reaction mixture streams or parallel production lines, respectively, each of which subsequently comprises a second pre-polycondensation reactor (PP2) and a final polycondensation reactor (finisher) which are connected in series in this order.

Since each shared reactor before each split is considered for each of the respective parallel production lines, each parallel production line includes the same number, type and order of the reactors as the single production line according to FIG. 7A. With this unit or plant configuration a polycarbonate production of up to 270 kta is possible at present.

FIG. 7D shows a process block diagram of a preferred process and unit or plant configuration of the invention including six parallel production lines. In this configuration the process is carried out in a production line comprising a pre-transesterification reactor (pre-TE reactor) and three transesterification reactors (TE1, TE2, TE3) which are connected in series in this order. After the last transesterification reactor (TE3) the reaction mixture stream or production line is split into two reaction mixture streams or parallel production lines, respectively, each of which subsequently comprises a first pre-polycondensation reactor (PP1) generating two parallel production lines. After the first pre-polycondensation reactor (PP1) of each parallel production line, the reaction mixture stream or production line is again split into three reaction mixture streams or parallel production lines, respectively, each of which subsequently comprises a second pre-polycondensation reactor (PP2) and a final polycondensation reactor (finisher) which are connected in series in this order.

Since each shared reactor before each split is considered for each of the respective parallel production lines, each parallel production line includes the same number, type and order of the reactors as the single production line according to FIG. 7A. With this unit or plant configuration a polycarbonate production of up to 540 kta is possible at present.

### EXAMPLES

### Reference Example 1

A production of polycarbonate in a melt transesterification process according to the prior art in which the initial phase was designed as described in FIG. 1 was performed with raw materials BPA and DPC having a minor quality. In particular, a BPA raw material having a fluctuating content of organic impurities and only a low average purity level of the BPA of about 99.6-99.8% was used.

Following the process steps described with respect to FIG. 1, the raw material melt mixture containing the transesterification catalyst is subject to the melt transesterification process steps according to the prior art. Namely, in the first transesterification reactor TE1 and following transesterification reactors continuous transesterification reaction of BPA and DPC to the transesterification product (monocarbonate MC) is carried out in three transesterification reactors in total connected in series. It develops at a process vacuum of approx. 0.5-0.05 bar (a) and a temperature in the range of 180 and 250° C., preferably 180 to 230° C., whereby a BPA conversion rate greater than 99% is aimed for.

The reaction column product of the transesterification reaction at the given process conditions of pressure (vacuum) and temperature is phenol in vapor form, which, due to the chemical-physical equilibria, is fed together with DPC vapors to a distillation column (process column) for separation.

The continuous polycondensation reaction is then carried out in several stages, namely pre-polycondensation in two pre-polycondensation reactors and final polycondensation in a final polycondensation reactor. To ensure the reaction rate over the several polycondensation steps, a polycondensation catalyst is added.

In particular, the transesterification product is continuously fed to a subsequent pre-polycondensation stage with two pre-polycondensation reactors connected in series. In the pre-polycondensation reactors 1 and 2, the temperature is increased to approx. 235-290° C., preferably 250-280° C. and the process pressure is further reduced to approx. 30-2.5 mbar (a), preferably 20 to 2.5 mbar (a). The vaporous phenol released by the chain growth is removed from the reactors by means of a vacuum system consisting of a process steam condensation stage, vacuum jet systems and vacuum pumps.

The final polycondensation takes place continuously in a special reactor in which the polymer mass is exposed to an increased temperature (280-320° C., preferably 290-310° C.) and reduced pressure of approx. 2-0.25 mbar (a), preferably 1.25-0.25 mbar (a) during the entire process, with an increased film evaporation area, for example through special stirring devices. Due to these conditions, the molecular growth reaction is strongly accelerated, resulting in a polymer melt with a high molecular weight and high viscosity.

The melt transesterification process using raw materials BPA and DPC having a minor quality lead to increased side reactions during the production process, including IPP formation and branching. As a result measured values of polydispersity (PD) of the polycarbonate produced resulted in values between 6 and 13 which is much too high. The acceptable PD value is 3 or less and a PD≤2.6 and ideally a value of 2 is desired.

### Reference Example 2

Based on the raw materials and transesterification catalyst used in Reference example 1, a pre-transesterification test was carried out in an analytical plant laboratory, in which the raw material melt was mixed with the transesterification catalyst in a raw material mixing tank, and the transesterification degree at 165° C. over the time was studied. The results are shown in FIG. 6.

The inventors surprisingly found that conversion is already possible in the raw material mixing tank at 165° C. and a residence time of about 2-3 minutes. Surprisingly, a reaction equilibrium was achieved at about 79-80% transesterification degree of the used BPA with DPC.

### Reference Example 3

In view of the results of Reference example 2, the melt transesterification process for the preparation of polycarbonate as described in Reference example 1 was changed in that the process scheme of the initial phase of FIG. 1 was modified by changing the position of the addition of the transesterification catalyst as shown in FIG. 2. In particular, the location of addition of the liquid transesterification catalyst TCAT in form of a solution was transferred from the feed position before inlet of first transesterification reactor TE1 to the feeding pipe in which the BPA feed and DPC melt flows before entering the mixing vessel MV.

Thus, the mixing vessel MV is operated as a so-called pre-reactor. By means of pumps, the pre-reacted raw material melt mixture was then fed to the first transesterification reactor TE1 via the preheater PH. The modified process scheme is shown in FIG. 2. However, in this configuration the transesterification degree in the first transesterification reactor TE1 fluctuated due to the continuing BPA raw material problem.

This was attempted to be compensated to some extent in that the temperature in the mixing vessel MV was raised to about 165° C. in order to increase the pre-reaction therein, though the inventors were aware that the BPA quality could also be further affected by this modification.

Once the polycarbonate production plant had been modified to such an extent that a pre-transesterification reaction was established in mixing vessel MV, the transesterification degree fluctuation range in the first transesterification reactor TE1 was also reduced- and above all, the polydispersity in the polycarbonate was ultimately reduced to a relatively normal range of values of PD=2.7-3.

However, this was still dependent on changes in the throughput of the entire polycarbonate production plant, as the dwell time in the mixing vessel MV inevitably also changes by the altered throughput and therefore the degree of pre-transesterification achieved fluctuated again.

### Example 1

Laboratory trials and trials in a small laboratory polycarbonate batch plant were carried out with the following experimental set-up for realizing a pre-transesterification by a 2-stage temperature ramp.

The raw materials used in this experimental set-up were:
200 g recrystallised bisphenol A
200 g distilled diphenyl carbonate
1 g tetraethylammonium hydroxide as a 25% solution in methanol (as the transesterification catalyst).

A mixture of BPA and DPC provided in a flask equipped with a magnetic stirrer and a reflux condenser was heated by means of a heating mantle to the melting temperature of BPA. Then the flask was transferred to a metal bath, while the transesterification catalyst was added to the mixture of BPA and DPC. The mixture of BPA, DPC and transesterification catalyst was further heated up to the target temperature (200° C.) for transesterification reaction by means of the metal bath.

The transesterification reaction was determined over the time. In this regard, after each test run, the remaining amount of DPC and BPA was determined via the HPLC method and the amount of phenol produced was determined on the basis of the transesterification reaction that had taken place.

The results are similar to those shown in FIG. 6. The results obtained were promising and it was shown that a BPA conversion of 80% wt.-% could be achieved after only 4 minutes of reaction time and at a temperature of 200° C. After 3 minutes the BPA content was already permanently reduced and the phenol content produced was constant at 20 wt.-%. However, the phenol content increased again from about 6-7 minutes onwards, which can be attributed to a thermal degradation reaction of DPC that now begins, with the elimination of phenol.

Implementation of these results by using pre-transesterification-reaction technology via the pre-transesterification reactor according to the invention in the continuous production of polycarbonate (cf. Example 2) has confirmed the results and demonstrated sustainably that
the target of the required degree of pre-transesterification in the raw
material melt mixture can be stably and permanently achieved and as a result, an increased robustness in polycarbonate production system can be achieved

### Example 2

A production of polycarbonate in a melt transesterification process according to the invention was carried out analogous to Reference example 1 or Reference example 3 except that the initial phase of the process was changed as described in FIG. 4. In particular, the pre-heater PH shown in FIGS. 1 and 2 was replaced by a pre-transesterification reactor according to FIG. 3 and the position of the addition of the transesterification catalyst was changed. For a general description, reference is made to FIGS. 4 and 5 and the description related thereto.

Based on the previous tests, the idea was developed (i) to integrate the preheater PH before entering the first transesterification reactor into a pre-transesterification reactor PTR and (ii) to relocate the feed point of the transesterification catalyst TCAT directly before entering the pre-transesterification reactor. Thus, no pre-reaction in the mixing vessel MV which is operated at atmospheric pressure is to be expected. Specific laboratory tests were carried out with the aim to minimize the residence time required for this pre-transesterification reaction so that the size of the heating zone in form of a heat exchanger could be minimized.

The pre-transesterification reactor PTR enables an operation with a fully filled residence time volume for a dwell time of 4-5 minutes in the reaction zone at any nominal plant throughput. The melt transesterification of BPA and DPC is a reversible reaction, and during the dwell time the reaction equilibrium is reached.

As already discussed with respect to FIG. 4, the pre-transesterification reactor PTR is designed with a lower heating zone in form of a heat exchanger section (tube-bundle heater) and a reaction chamber above it (which is always filled with and flowed through with monomer melt) including an integrated static mixer with sufficient mixing quality for edge flow exchange and heating on the jacket side. The reaction chamber is equipped with a heating device such as a heating jacket or heating coil or external heat exchanger to maintain the desired reaction temperature.

The transesterification catalyst TCAT in form of a solution is now dosed directly and continuously into the raw material melt feed line before entering the pre-transesterification reactor PTR. On the way to the pre-transesterification reactor PTR, the prepared catalyst-containing raw material melt is mixed with a static mixer, then continuously fed to the heating zone of the pre-transesterification reactor PTR, i.e. lower vertical part (tube-bundle heater) and heated via this heat exchanger to approx. 175-205° C., preferably to a temperature range of 185-195° C. The pressure condition in the pre-transesterification reactor PTR is in the range of 5 to 1 bar (a), preferably from 5 to 1.1 bar (a), more preferably from 3.5 to 1.5 bar (a), more preferably from 3 to 2 bar (a).

The heated raw material melt mixture including the transesterification catalyst flows through the reaction zone, i.e. the upper section of the pre-transesterification reactor PTR. Therein, 79% or more of the BPA contained in the raw material melt mixture reacts with the DPC to form the monomer (transesterification). At this point, the state of the reaction mixture is saturated which means that the reaction equilibrium is reached. The product flowing out (saturated monomer melt) flows continuously to the first transesterification reactor TE1′.

This outgoing product stream (saturated monomer melt), which flows continuously to the first transesterification reactor TE1′, now mainly consists in its composition of
not yet reacted raw materials bisphenol-A (BPA) and diphenyl carbonate (DPC), and
phenol (PEOH) formed by transesterification reaction of BPA with DPC as a cleavage product also called split phenol, and of course
transesterification product or monomer obtained by transesterification reaction, here called monocarbonate (MC), i.e. the 1:1 BPA/DPC product.

Assuming as an example for the produced monocarbonate an achieved chain length of n=1 at a BPA transesterification degree of 80% (i.e. 0.8 mol BPA of 1 mol feed BPA has reacted with DPC), then theoretically the following transesterification reaction via the pre-transesterification reactor PTR would result- and the corresponding molar balance or composition of the input and output streams, based on 1 mol BPA as raw material. This theoretical pre-transesterification would relate to:

$$1 mol BPA + 1.05 mol DPC \text{=>} 0.8 mol MC + 0.8 mol PEOH + ( 1 - 0.8 ) mol BPA + ( 1.05 - 0.8 ) mol DPC .$$

The resulting split phenol fraction is now part of the feed stream into the first transesterification reactor TE1′. If this amount of split phenol is continuously fed into the first transesterification reactor TE1′ below its product liquid level, as in the original design, then a reverse or degradation reaction could occur within the reaction melt due to the presence of the phenol.

To avoid this, a preferred embodiment is configured such that the product inlet flow into the reactor TE1′ is now fed tangentially above the liquid level of reactor TE1′ by means of three feed nozzles distributed around the circumference, namely into an “overflow balcony” located in the upper cylindrical area of the reactor. This overflow balcony serves as an overflow channel by which a falling film of the entering pre-transesterified reaction mixture is generated. The pressure difference between the inlet pressure and the pressure in the TE1′ reactor enables a rapid evaporation of the introduced split phenol from the inlet stream (flash evaporation). A pressure regulating valve located at a vapor line to manage the pressure difference between the pre-transesterification reactor and the first transesterification reactor enables control of the flash evaporation. The generated falling film further enables a “falling film evaporation” of the remaining phenol out of the inlet stream due to the overflow of the inlet product with phenol residue over the upper edge of the inner balcony.

Thus, the filling volume in the transesterification reactor TE1′ is fed with pre-transesterified reaction mixture substantially without phenol content, which consequently strongly favors further progress of the transesterification reaction without back-reaction influences due to the presence of excess phenol in the liquid phase of the reaction stage.

This innovative design of a combination of pre-transesterification reactor PTR and a flash stage in the first transesterification reactor TE1′ thus enables an optimal transesterification reaction environment with a simultaneously very effective evaporation of the vaporous phenol phase, whereby the desired process pressure (reaction pressure) in the TE1′ reactor is set and controlled by means of a control valve in the vapor line.

The results of the overall process demonstrate that by using pre-transesterification-reaction technology via the pre-transesterification reactor according to the invention in the continuous production of polycarbonate the target of the required degree of pre-transesterification in the partially transesterified reaction mixture (pre-transesterification product) can be stably and permanently achieved and, as a result, an increased robustness in polycarbonate production system can be achieved. The polydispersity of the polycarbonate obtained is below 3.

### REFERENCE SIGN LIST

MV mixing vessel
PH pre-heater
PTR pre-transesterification reactor (in FIG. 7A-D: pre-TE reactor)
TE1 first transesterification reactor
TE1′ first transesterification reactor with overflow means
TE2 second transesterification reactor
TE3 third transesterification reactor
PP1 first pre-polycondensation reactor
PP2 second pre-polycondensation reactor
Finisher final polycondensation reactor
TCAT transesterification catalyst
IN inlet for the feed of the raw material melt mixture
OUT outlet for the feed of the partially transesterified reaction mixture
HZ heating zone
RZ reaction zone or reaction chamber
DP discharge pump
SM static mixer
HTM heat transfer medium
FC flow rate control
LC level control
TC temperature control
PC pressure control

1. A reactor, in particular suitable as an element in a plant for continuous production of a polymer, preferably a polycarbonate, based on a raw material melt mixture, wherein the reactor comprises;
a) a heating zone provided with one or more heating means for heating the raw material melt mixture to a predetermined temperature,
b) a reaction zone for reacting the heated raw material melt mixture, wherein the reaction zone is located above the heating zone and provided with one or more mixing means,
c) an inlet for the raw material melt mixture at the bottom of the heating zone and
d) an outlet for the reacted raw material melt mixture at the top of the reaction zone,
wherein the reactor is configured to carry out the reaction at a pressure of equal to or above 1 bar (a) in the reaction zone entirely filled with the heated raw material melt mixture flowing through the reaction zone.

2. The reactor according to claim 1, wherein the reactor is a pre-transesterification reactor.

3. The reactor according to claim 1, wherein the reactor is a vertical reactor.

4. The reactor according to claim 1, wherein the heating zone provided with one or more heating means is in form of a heat exchanger.

5. The reactor according to claim 1, wherein the heating zone provided with one or more heating means is in form of a tube-bundle heater configured to heat the raw material melt mixture in the tubes of the tube-bundle heater to a predetermined temperature.

6. The reactor according to claim 1, wherein the one or more mixing means in the reaction zone are one or more integrated static mixers.

7. The reactor according to claim 1, wherein the reaction zone is provided with internal heating means and/or external heating means to essentially maintain the predetermined temperature of the heated raw material melt mixture in the reaction zone, wherein external heating means are preferably one or more heating jackets and/or external heating coils and internal heating means are preferably one or more internal heating coils and/or heating tubes.

8. The reactor according to claim 1, wherein the reactor does not contain outlets for removing possible by-products generated during the reaction in the reaction zone.

9. The reactor according to claim 1, wherein the reactor is configured to provide a dwell time of the raw material melt mixture in the reaction zone, the dwell time being in the range of 2 to 7 min, preferably 3 to 6 min, more preferably 4 to 5 min.

10. The reactor according to claim 1, wherein the reactor is configured to carry out the reaction in the reaction zone at a temperature in the range of 175 to 205° C., preferably from 180 to 200° C., more preferably from 185 to 195° C., and a pressure in the range of 5 to 1 bar (a), preferably from 5 to 1.1 bar (a), more preferably from 3.5 to 1.5 bar (a), more preferably from 3 to 2 bar (a).

11. The reactor according to claim 1, wherein the reaction in the reaction zone is a transesterification reaction, preferably a partial transesterification reaction, and/or
wherein the raw material melt mixture comprises one or more bisphenols, preferably bisphenol A, one or more diaryl carbonates, preferably diphenyl carbonate, and one or more transesterification catalysts, and/or wherein the reacted raw material melt mixture leaving from the outlet of the reactor comprises monoesters, preferably monocarbonates, unreacted raw materials and monomeric by-products such as alcohol compounds.

12. A unit, in particular suitable as a component in a plant for continuous production of a polymer, preferably a polycarbonate, based on a raw material melt mixture, wherein the unit comprises;
i) a first reactor which is a reactor according to claim 1, and
ii) a second reactor provided with one or more inlet nozzles for receiving the reacted raw material melt mixture from the first reactor, and at least one outlet for removing evaporated by-products, wherein the second reactor is configured to further react the reacted raw material melt mixture received from the first reactor at a pressure of below 1 bar (a) to generate a reaction mixture with a gaseous phase filling an upper part of the reactor where the one or more inlet nozzles are located,
wherein the first reactor and the second reactor are connected in series in this order.

13. The unit according to claim 12, wherein the second reactor is equipped with a pressure regulating valve located at a vapor line to manage the pressure difference between the first reactor and the second reactor enabling controlled flash evaporation of by-products in the second reactor.

14. The unit according to claim 12, wherein the second reactor is further provided with overflow means, preferably an overflow balcony, located at an upper portion of the second reactor, wherein the outlet of the first reactor is connected with the one or more inlet nozzles of the second reactor such that the reacted raw material melt mixture from the first reactor can be fed to the overflow means from which it can overflow to form a falling film in the gaseous phase of the second reactor, wherein it is preferred that the reacted raw material melt mixture from the first reactor can be tangentially fed to the overflow means.

15. The unit according to claim 14, wherein the overflow means, in particular, the overflow balcony, is disposed circumferentially at an inner wall of the second reactor.

16. The unit according to claim 12, wherein the second reactor is a transesterification reactor and/or wherein second reactor is a vertical reactor.

17. The unit according to claim 12, wherein the second reactor is a stirred-tank reactor.

18. The unit according to claim 12, wherein the second reactor is configured to carry out the reaction at a temperature in the range of 180 to 250° C., preferably 180 to 230° C., and a pressure of 0.5 to 0.05 bar (a), preferably 0.5 to 0.1 bar (a).

19. The unit according to claim 12, wherein;
the first reactor is a pre-transesterification reactor configured to form a partially transesterified reaction mixture as the reacted raw material melt mixture containing an alcohol compound as a by-product, wherein the raw material melt mixture preferably comprises one or more bisphenols, preferably bisphenol A, one or more diaryl carbonates, preferably diphenyl carbonate, and one or more transesterification catalysts, and
the second reactor is a transesterification reactor configured to continue transesterification of the partially transesterified reaction mixture received from the first reactor and to remove the alcohol compound by-product generated in the first and second reactor.

20. The unit according to claim 12, further comprising one or more further reactors connected in series subsequently to the second reactor to further react the reaction mixture received from the second reactor, wherein it is preferred that i) the first reactor is a pre-transesterification reactor configured to receive and react the raw material melt mixture at a pressure equal to or above 1 bar (a) to form a partially transesterified reaction mixture containing a cleaved alcohol compound as a by-product as the reacted raw material melt mixture,
ii) the second reactor is a first transesterification reactor configured to continue transesterification of the partially transesterified reaction mixture received from the first reactor at a pressure of below 1 bar (a) with continuous removal of the cleaved by-product,
iii) the one or more further reactors are in this order
a) at least one further transesterification reactor configured to continue transesterification of the transesterified reaction mixture received from the second reactor at a pressure of below 1 bar (a) with continuous removal of the cleaved by-product,
b) at least one pre-polycondensation reactor configured to polycondense the transesterified reaction mixture received from the at least one further transesterification reactor at a pressure of below 1 bar (a) with continuous removal of the cleaved by-product to form a pre-polycondensation product, and
c) a final polycondensation reactor configured to continue polycondensation of the pre-polycondensation product formed in the at least one pre-polycondensation reactor at a pressure of below 1 bar (a) to form a polyester, preferably a polycarbonate.

21. Use of a unit according to claim 12 as an element in a plant for continuous production of a polymer, preferably a polyester, more preferably a polycarbonate, wherein the reactor or first reactor, respectively, is preferably used to carried out a transesterification reaction on a raw material melt mixture to obtain a partially transesterified reaction mixture.

22. The use according to claim 21, wherein the second reactor is used to continue transesterification reaction on the partially transesterified reaction mixture received from the first reactor.

23. The use according to claim 21 to improve the polydispersity of the polymer produced, in particular the polycarbonate produced, and/or to improve the robustness or flexibility of the polymer production, in particular the polycarbonate production.

24. A process for continuous production of a polymer, preferably a polycarbonate, in a plant, wherein the plant comprises a reactor according to claim 1.

25. The process of claim 24 for continuously producing a polycarbonate in the plant, wherein the reactor according to claim 1 is used as a pre-transesterification reactor, and a second reactor according to connected with the pre-transesterification reactor is used as a first of at least two transesterification reactors, wherein the plant comprises a mixing vessel, the pre-transesterification reactor, the at least two transesterification reactors, at least one pre-polycondensation reactor and a final polycondensation reactor connected in series in this order, wherein the process comprises at least the following steps:
a) mixing a melt of one or more bisphenols with one or more diaryl carbonates in the mixing vessel to form a raw material melt,
b) adding one or more transesterification catalysts to the raw material melt, preferably after the raw material melt has left the mixing vessel, to form a raw material melt mixture containing the one or more transesterification catalysts,
c) pre-transesterifying the raw material melt mixture containing the one or more transesterification catalysts in the pre-transesterification reactor at a pressure of equal to or above 1 bar (a) to form a partially transesterified reaction mixture containing cleaved hydroxyaryl compound,
d) continuing transesterification of the formed partially transesterified reaction mixture in the at least two transesterification reactors at a pressure of below 1 bar (a) with continuous removal of cleaved hydroxyaryl compound to form a transesterified reaction mixture,
e) polycondensing the formed transesterified reaction mixture in the at least one pre-polycondensation reactor at a pressure of below 1 bar (a) with continuous removal of cleaved hydroxyaryl compound to form a pre-polycondensation product,
f) continuing the polycondensation of the formed pre-polycondensation product in the final polycondensation reactor at a pressure of below 1 bar (a) to form polycarbonate.

26. The process according to claim 25, wherein the at least two transesterification reactors are connected with a process column for removal of the hydroxyaryl compounds to which an additional diaryl carbonate recovery column is connected.

27. The process according to claim 25, wherein a heat exchanger is connected upstream the inlet line of the final polycondensation reactor.
